(19) United States
(12) Patent Application Publication
(10) Pub. No.: US 2002/0057360 A1
(43) Pub. Date: May 16, 2002

(54) Auxiliary device module

(76) Inventors: Kimihiro Abe, Shizuoka (JP); Isao Kameyama, Shizuoka (JP); Takakazu Takahashi, Shizuoka (JP); Takayoshi Endo, Shizuoka (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/983,534

(22) Filed: Oct. 24, 2001

(30) Foreign Application Priority Data
Oct. 25, 2000 (JP) 2000-325877

(51) Int. Cl. H04N 5/225

(52) U.S. Cl. 348/373

(57) ABSTRACT

An auxiliary device module Z includes an auxiliary device 1 such as a camera 1, a base board 2 provided with the auxiliary device 1, a pressure contact type connector 5a and pressure contact type terminals 5e and a case 3 in which the base board can be mounted. The pressure contact type terminals 5e and a connecting portion 5e′ including electric wires 4a, 4a′ in the case 3 are electrically connected as a connector 5 by mounting the base board 2 on the case 3. Guide portions 6a for guiding the pressure contact type terminals 5e to the connecting portion 5e′ are provided in the connector 5. In this configuration, when fitting the base board 2 into the case 3, electrically connecting can be done simultaneously and securely.

### BACKGROUND OF THE INVENTION

1. Field of the Invention

This invention relates to an auxiliary device module with high manufacturability and high yield by connecting electrically an auxiliary device, such as a car-mount type CCD camera, and a base board mounted on the auxiliary device and a case, on which the auxiliary device and the board can be mounted, by means of a connector.

2. Description of the Related Art

A camera module Y, Z by prior art will be described with reference to FIG. 21-24. FIG. 21 is a partial expanded view of a wire harness 4 mounted with a clamp 10 having an O-ring 11. The O-ring 11 is provided in the clamp 10 to keep a camera case 3 airtight when mounting the clamp 10 on the camera case 3.

The clamp 10 is provided with a thread portion 10a for fixing it securely on a camera case and a hexagon head portion 10b to be used when the clamp 10 is fixed on a camera case by thread fastening and a flange 10c to generate fastening force between the clamp 10 and the camera case 3 and perform keeping the O-ring 11 airtight.

The clamp 10 is provided inside thereof with a through hole 10d to run electric wires or the like, such as cables 4a, 4a′, through. As shown in FIG. 21, electric wires of cables 4a, 4a′ including a drain wire 4a′ run through the through hole 10d of the clamp 10 having the O-ring 11. Terminals 5p are mounted on the end of respective cable 4a, 4a′.

After putting the cables 4a, 4a′ through the through hole 10d of the clamp 10, potting process 12 is done. Describing potting process 12 simply, it is sealing by pouring soft rubber or soft resin such as epoxy polymer in required portion.

Sealing for each cable 4a, 4a′can be done completely by potting process 12. Then, penetrating of water or dust into inside of a camera case or camera is prevented. Sealing test on a potting processed portion can be done by leakage test on water or air.

FIG. 22 and FIG. 23 are perspective views, showing assembling process of camera modules Y, Z with a car-mount type CCD camera Y by prior art. A camera module Y with a car-mount type CCD camera by prior art will be described simply here. The camera module Y comprises a camera 1 such as a car-mount type CCD camera and a base board 2 mounted with the camera 1. A camera module Z is provided with a camera module Y having a camera 1 and a base board 2, a camera case 3 mounted with the camera module Y and a wire harness 4 formed with bound various cables 4a, 4a′.

FIG. 22 and FIG. 23 show assembling process of a car-mount type CCD camera by prior art. FIG. 23 is a perspective view, showing wrong condition when mounting the camera module Y with the camera 1 and the base board 2 on the camera case. FIG. 24 is a conceptual drawing, showing a condition of mounting the wire harness 4 on the camera case 3 through the clamp 10 by partially expanded view.

Describing CCD simply here, CCD is a charge coupled device to convert to electrical signals from optical signals of images by optical sensing semiconductors. CCD is an abbreviation of Charge Coupled Device and is a semiconductor, introduced by Bell Laboratory, U.S.A. in 1970. In general, image quality of CCD is determined by number of pixels and the number of pixels on CCD is designed widely from several 100 K to several million. The number of pixels on CCD will be increased more for market requirement.

CCD is used in many applications of cameras such as digital cameras or video cameras, facsimiles, scanners or copy machines such as copiers or laser printers. In digital cameras, CCD is placed on a focus point instead of a silver film. Recently, a price of CCD with large number pixels is going down and then it contributes to low price and high quality image of digital cameras.

Each part of the camera module Z by prior art shown in FIG. 22-23 is described in detail. The camera 1 is provided with a lens 1c and a lens area portion 1d to hold the lens 1c. The base board 2 mounted with the camera 1 includes mainly a base board body 2′ provided with electric elements such as connectors for electrical connecting. The base board body 2′ is provided with a connector housing 2c as a connector related element. The base board body is also provided at four locations near four corners thereof with screw through holes 2b for fixing the base board 2 on the camera case 3 by fastenings such as screws 13b.

The camera case 3 is formed with a bottom wall 3c and side wails 3d, 3d′ standing around the bottom wall to provide a receiving section 3e. The side wall 3d′ is provided with a cylindrical projection 3g for fixing the clamp 10 and sealing the camera case 3. The camera case 3 is provided on four corners inside the receiving section 3e with screw fixing bodies 3a for fixing the base board 2 mounted with the camera 1 thereon. Each screw fixing body 3a has a tapped hole 3b.

Joint structure of the clamp 10 and the camera case 3 shown in FIG. 22, 23 is described in detail with reference to FIG. 24. The camera case 3 is provided on the side wall 3d′ with a through hole 3f for putting the wire harness 4 formed by bound cables 4a, 4a′ through. The through hole 3f is formed inside wall thereof with internal tread portion to combine with the thread portion 10a of the clamp 10 for fastening.

The clamp 10 with led cables 4a, 4a′ shown in FIG. 21 through is mounted in the through hole 3f formed on the side wall 3d′ of the camera case 3. Combining the thread portion 10a of the clamp 10 and the through hole 3f, formed with thread, of the camera case 3, the clamp 10 with led wire harness 4 shown in FIG. 24 through is fixed on the camera case 3.

The camera case 3 is provided around the through hole 3f with the cylindrical projection 3g for guiding the clamp 10 with the O-ring 11, mentioned above, into the through hole 3f. The cylindrical projection 3g performs shield plate to keep hermetic sealing by the O-ring mounted on the clamp 10 and to prevent penetrating of water or dust from outside.

The wire harness 4, as shown in FIG. 24, connects the camera case 3 and a non-waterproof connector 5r mounted in an inside-of-car V. The drain wire 4a′ branched at a middle portion of the wire harness 4 is provided at the end with a terminal 5s and the terminal 5s is mounted on a frame of a car body B by means of a screw 13c. Thus, the drain wire 4a′ performs earth ground.

Inserting a connector housing 5q joined with the cables 4a, 4a′ into connector housing 2c, as shown in FIG. 22, 23, builds a connector and connects electrically the cables 4a, 4a′ and the camera 1 such as a car-mount type CCD camera. Thus, the base board 2 with the camera 1, the wire harness 4, the non-waterproof connector 5r mounted in the inside-of-car V, the drain wire 4a′ and the like are respectively connected electrically.

An example of assembling process for a car-mount type CCD camera by prior art will be described in detail as follows. The clamp 10 with the O-ring 11 is mounted on the wire harness 4, shown in FIG. 13. After inserting the wire harness 4 formed by bound cables 4a, 4a′ through the through hole 10d of the clamp 10, the wire harness 4 and the clamps 10 are temporally fixed.

On a portion of the wire harness 4 from the clamp 10 inward the camera case 3, a tube 4d for binding and protecting cables 4a, 4a′ is cleaved by a cutter or the like for pulling the cables 4a, 4a′ out from the tube 4d . The terminals 5p are joined with the end of respective cables 4a, 4a′ and the terminals 5p are received in the connector housing 5q, shown in FIG. 22, to build up connector related elements.

To improve sealing performance of such wire harness 4 and the clamp 10, potting process 12 by pouring resign or rubber into the through hole 10d of the clamp 10 is done and the both of the wire harness and the clamp is fixed, as shown in FIG. 21. The potting process shown in FIG. 21 and 24 enhances airtight performance of the camera case 3.

Assembling operation of the electric wire 4 and related elements as mentioned above can be called as “assembling of the wire harness 4 and a connector” or more simply “connector assembling”. The clamp 10 is fixed at a suitable position of the wire harness 4 for allowing the cables 4a, 4a′ to have an extra length to connect the camera case 3 with the base board 2.

The clamp 10, inserting the cables 4a, 4a′ therein, mentioned above, is mounted into the through hole 3f of the camera case 3, as shown in FIG. 24. Thereafter, combining the thread portion 10a of the clamp 10 with the O-ring 11 with the through hole 3f (treaded hole) of the camera case 3, the clamp 10 is fixed on the camera case 3 as shown in FIG. 22-24. The O-ring 11 and potting process 12 give airtight and sealing performance of the camera case 3, as shown in FIG. 24.

After above operation, the camera module Y which is the base board 2 mounted with the camera 1 is mounted on the camera case 3. The operation process is connecting the connector elements, including the connector housing 5q provided in the wire harness 4, with the connector elements including the connector housing 2c mounted on the base board body 2′.

After connecting connectors or the like mentioned above, the camera module Y is mounted on the camera case 3. Regarding mounting process, the camera module Y provided with the camera 1 and the base board 2 is mounted on the camera case 3 to place the screw through hole 2b provided in the base board 2 corresponding to the tapped hole 3b provided on the four corners of the camera case 3.

Inserting the screws 13b into each the screw through hole 2b provided in the base board body 21, the screws are turned by a screw fastening means. Then, the screws 13b go into the tapped holes 3b provided on the camera case 3. Thus, the camera module Y is fixed on the camera case 3 and then the camera module Z is assembled.

When looking related arts, J.U.M. Application Laid-open H7-42075 exists. J.U.M. H7-42075 describes a connector connecting system and discloses a wire alignment and hold mechanism to align automatically respective pair wire without changing coupled order on a connector connecting system to connect automatically respective conductive core wire of a plurality of pair wires into a temporally fixing connector cover.

Objects to be Solved

However, according to a camera module by prior art, as shown in FIG. 22 and 23, operation for connecting the camera module Y and a connector joined with the end of the cable 4a is done manually and then complicated work is required to operators. Furthermore, operations of placing the cables 4a, 4a′ in the receiving section 3e of the camera case 3 and fixing them by the clamp 10 and connecting connectors are poor efficient work.

Describing an actual case, the camera case 3 by prior art is provided with the through hole 3f for inserting the cables 4a, 4a′ therein and the cables 4a, 4a′ with a connector is put through the through hole 3f and the connector is connected with a connector mounted on the base board 2. Such operation is very complicated for operators.

The camera case 3 by prior art is provided with the through hole 3f for inserting the cables 4a, 4a′ and the through hole 3f is threaded. Keeping sealing performance of the through hole 3f , operation of screwing the clamp 10 into the thread portion and fixing the clamp 10 with the wire harness 4 on the camera case 3 is required.

FIG. 23 is a perspective view at a time of bad situation occurred during mounting the camera module Y on the camera case 3. During mounting the camera module Y by prior art on the camera case 3, it is feared that the cables 4a, 4a′ are bitten by the camera module and the camera case as shown in FIG. 23.

In addition to above issue of biting the cables 4a, 4a′, even if electrical connection is done with a connector provided with pressure contact terminals, the operation for connecting electrically a pressure contact terminal and corresponded electric wire may be done by watching from oblique direction through a gap between the base board 2 and the camera case 3 or by blind touch. Such operation requires much attentiveness and load for operators and manufacturability is low. Unsecured pressure contact connection is also concerned.

One object of this invention is to provide an auxiliary device module which is miniaturized and reduced on weight by minimizing number of elements provided around the auxiliary device such as a camera, wherein connection of electric wires such as a wire harness and a base board having the auxiliary device such as a camera and terminals such as pressure contact type terminals is done simultaneously when mounting the base board on a case.

Furthermore, the other object is to overcome the above drawback which is that electric wires such as cables is bitten when mounting the base board provided with an auxiliary device such as a camera on a case, as shown in FIG. 23. Simultaneously, reduction of fraction defective when connecting electrically connectors and speed-up and higher efficiency of assembling operation are the other objects. Specifically, the object is that a slit of a pressure contact blade formed on a pressure contact type connector abuts on a right position of an electric wire such as cable or conductive core wire and contacts it securely.

### SUMMARY OF THE INVENTION

How to Attain the Object

In order to attain the objects, according to the invention, there is provided an auxiliary device module comprising an auxiliary device, a base board provided with the auxiliary device and terminals and a case mounted with the base board provided with the auxiliary device, wherein the terminals on the base board and a connecting portion inside the case are electrically connected as a connector by mounting the base board on the case, wherein a guide portion for guiding the terminals to the connecting portion is provided on the connector.

Since an auxiliary device, a base board and a case are modularized by above means and number of related elements can be reduced, the auxiliary device module is miniaturized and reduced on weight and also assembly structure is simplified. Mounting the base board provided with an auxiliary device and terminals on the case, assembling and electrical connecting can be done simultaneously.

No defective units concerned during assembling by prior art can be realized. On a device by prior art, while mounting the base board provided with an auxiliary device on the case, an electric wire may be bitten by a gap between the base board and the case. Such auxiliary device module with bitten electric wire is judged as a defective unit by concerning open circuit in an electric wire inside.

Abandoning such unfinished products is undesirable for terrestrial environment and wasteful on manufacturing. Then, reassembling such module to replace elements related with electric wires is required. According to this invention, such defective units can be eliminated without such troublesome operations.

Furthermore, since the connector formed in the auxiliary device module is provided with a guide portion for guiding terminals to a connecting portion, the terminals are guided into required position of the connector securely and then electric connection can be done easily and securely when mounting a base board with terminals on the case.

Thus, operators are not required to pay too much attention when assembling an auxiliary device module and connecting of connectors assembled by automatic assembling machines is satisfactory. Therefore, speed-up and enhancement on assembling operation can be done and then, a low cost and low fraction defective auxiliary device module can be provided.

An auxiliary device module according to the invention is the auxiliary device module mentioned above, wherein said terminals are pressure contact type terminals, wherein said connecting portion has electric wires, wherein a pressure contact type connector provided with said pressure contact type terminals are mounted on said base board, wherein said case is provided with a connector housing having said electric wires therein, wherein said connector is formed by press-fitting said base board into said case to connect said pressure contact type terminals with said electric wires by pressure, wherein said guide portion is formed with a plurality of openings, wherein at least one of a plurality of said pressure contact type terminals, guided through the openings, is connected by pressure with a plurality of the electric wires corresponding to the terminals.

Thus, operation of electrical connecting can be done easily by pressure contacting connection with pressure contact type terminals. Describing the operation for connecting electric wires with pressure contact type terminals, a pressure contact blade formed on a pressure contact type terminal is pressed on an electric wire such as a cable protected with a insulation cover and a sharp slant portion of the pressure contact type terminal is shearing the cable insulation cover made of resin or rubber and a conductive wire insulation coating such as enamel coating.

Pressing the terminal more, a pressure contact slit formed in the center area of the pressure contact type terminal shears the cable insulating cover more and contacts a inductive wire in the cable. Therefore, stripping the insulating cover and contacting the conductive wire are done simultaneously.

Thus, electrical connecting is given by contacting a U-shape pressure contact slit with a inductive wire in a cable or in an enamel coated wire. In short, electrical connection is given by pressing a pressure contact blade on a required portion of a covered inductive wire of a cable or enamel coated wire. Since operation of assembling an auxiliary device, a base board with pressure contact type connector and a case, mentioned before and operation of pressure contacting connection mentioned above can be done together and simultaneously, electrical connection can be done by assembling a base board provided with an auxiliary device and a case.

Regarding an auxiliary device module by prior art, operation of connecting a pressure contact type terminal with an electric wire requires to pay much attention. An auxiliary device module failed in continuity test after operating pressure contact connection is treated as a defective product.

If pressure contact connection is applied again on the same position of electric wire which had be sheared once by a pressure contact type terminal, the second electrical disconnection on the position is concerned. Therefore, an electric wire applied pressure contact connection must be replaced or the other position of the electric wire instead of the position applied pressure contact connection previously may be connected with a pressure contact type terminal.

However, in a module by this invention, a connector formed in an auxiliary device module is provided with a opening portion to guide a pressure contact type terminal and then when mounting a base board mounted with the pressure contact type terminals on a case, electrical connection can be done by guiding securely the pressure contact type terminals on the electric wires in a connector housing. Therefore, failed products mentioned above can be reduced and product yield can be improved.

Describing in detail, since a connector housing is provided with a plurality of openings for guiding and at least one pressure contact type terminal in a plurality of the terminals corresponding to the openings is connected with electric wires, such as a cable, corresponding to the terminals to be guided by the openings, a pressure contact slit formed in the pressure contact type terminal is guided securely to pressure-contact to the electric wires, such as a cable, in the connector and then electric connection can be done securely.

An auxiliary device module according the invention is the auxiliary device module mentioned above, wherein a camera module is built with a car-mount type camera as said auxiliary device.

Applying the auxiliary device module according the invention for camera module mounted in a car, number of elements related with the camera module can be reduced and then, the camera module mounted in a car can be miniaturized and the weight and the cost also can be reduced.

Assembling structure of a camera, a base board and a case for a car is simplified. Using pressure contact type terminals, the structure differs from a current camera module in which a crimp contact type terminal is joined with a cable and connected with a connector for a board and electrical connection is done by a pressure contact type connector and then inspection, disassemble and repair can be done easily and also the camera module having good recyclability can be provided.

### BRIEF DESCRIPTION OF THE DRAWINGS

FIG. 1 is a FIG. 1 is an exploded perspective view of one embodiment of an auxiliary device module according to the invention;

FIG. 2 is a conceptual drawing to show a top view of a case shown in FIG. 1 and connection of electric wires;

FIG. 3 is an expanded perspective view of a pressure contact type connector shown in FIG. 1;

FIG. 4 is an outline drawing, showing expanded connection area of pressing the cables into the pressure contact type terminal shown in FIG. 3;

FIG. 5 is a partial expanded perspective view, showing mounting the cables in the wire fixing portion;

FIG. 6 is a sectional view taken along the line P-P of FIG. 1 showing the connecting case and the connecting case cover;

FIG. 7 is a top view of other embodiment of an auxiliary device module according to this invention;

FIG. 8 is a top view of a case and its surrounding areas shown in FIG. 7;

FIG. 9 is a plan view of a pressure contact type connector mounted on the case shown in FIG. 7 and a base board provided with an auxiliary device;

FIG. 10 is a sectional view taken along the line Q1-Q1 of the auxiliary device module shown in FIG. 7;

FIG. 11 is a sectional view taken along the line Q2-Q2 of the case and its surround areas shown in FIG. 8;

FIG. 12 is a side view of the base board provided with the auxiliary device and the pressure contact type connector shown in FIG. 9;

FIG. 13 is a sectional view taken along the line R1-R1 of the auxiliary device module shown in FIG. 7;

FIG. 14 is a sectional view taken along the line R2-R2 of the case and its surround areas shown in FIG. 8;

FIG. 15 is a front view of the base board provided with the auxiliary device and the pressure contact type connector shown in FIG. 9 and 12;

FIG. 16 is a front view seeing from a side of an electric wire of the auxiliary device module shown in FIG. 7 and 10;

FIG. 17 is a front view seeing from a side of a connecting case of the case and its surround areas shown in FIG. 8 and 11;

FIG. 18 is an expanded view, showing starting process for connecting the pressure contact type terminal with the cable, shown in FIG. 13, through a guide portion;

FIG. 19 is an expanded view, showing process after starting for connecting the pressure contact type terminal with the cable, shown in FIG. 18, through the guide portion;

FIG. 20 is an expanded view, showing finished condition for connecting the pressure contact type terminal with the cable, shown in FIG. 19;

FIG. 21 is a partial expanded view of a wire harness mounted with a clamp having an O-ring;

FIG. 22 is a perspective views, showing assembling process of camera modules by prior art;

FIG. 23 is a perspective views, showing a trouble condition when fitting a camera module in a camera case by prior art; and

FIG. 24 is a conceptual drawing, showing a partial expanded sectional view taking along the line R2-R2 of FIG. 22, 23 and condition of connecting the wire harness.

### DESCRIPTION OF THE PREFERRED EMBODIMENT

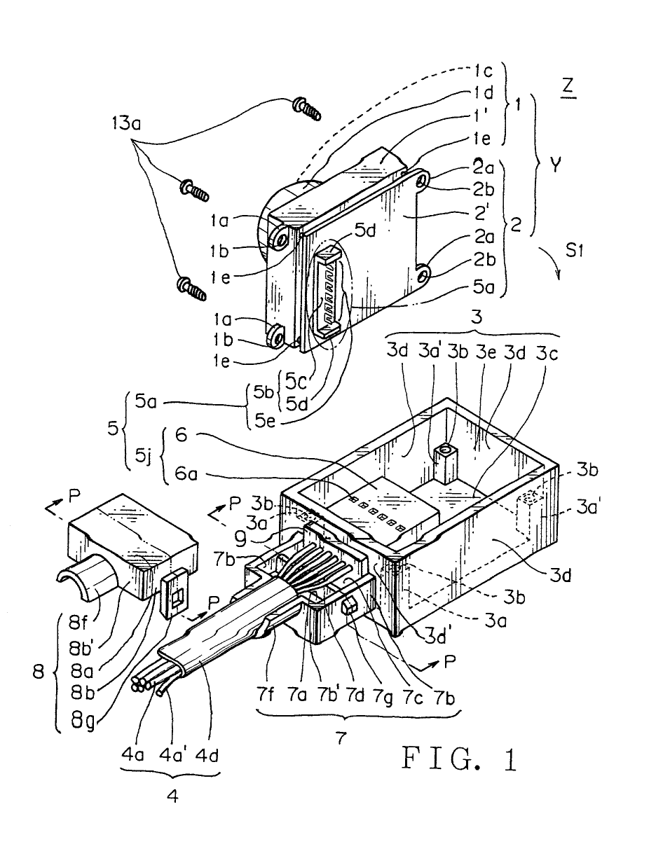

A camera module Z as an embodiment of an auxiliary device module according to this invention will now be described with reference to FIG. 1-20. The same named elements as respective elements in the example by prior art, mentioned above, are put with the same number and the detailed description on the structure is omitted.

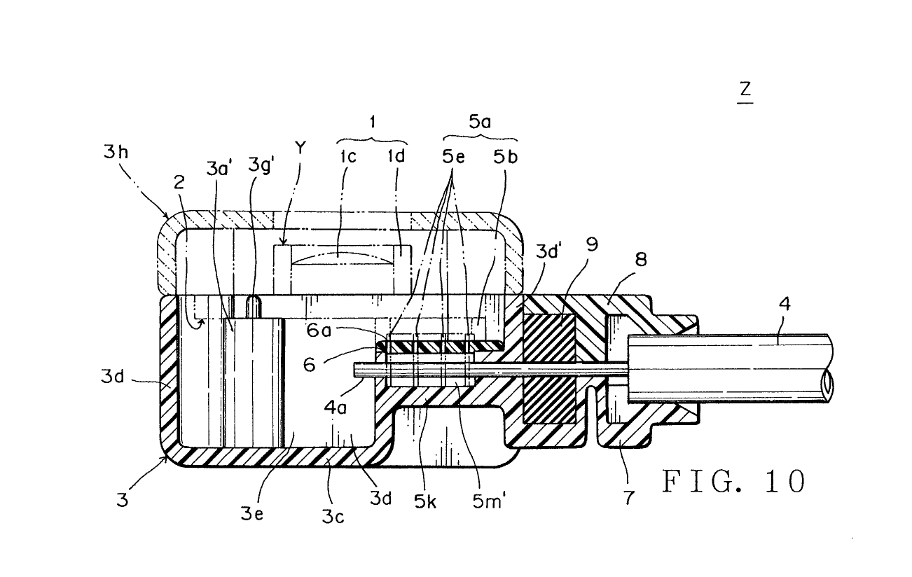

Regarding definition of upper-and-lower and front-and-rear direction in FIG. 1 and 10, a side of a lens 1c in an assembled camera module Z is the upper side and a side of a bottom wall 3c in a camera case 3 is the lower side. A direction of an electric wire 4, such as a wire harness 4, extending from the camera case 3 is the front side or this side and the opposite direction is the rear side or the back side.

Assembly provided with at least two elements like an auxiliary device 1 such as a camera 1 having a base board 2 is defined as an auxiliary device module Y and specifically is called a camera module Y. Assembly provided with at least three elements like an auxiliary device 1 such as a camera 1 and a base board 2 mounted on the auxiliary device 1 such as the camera 1 and the camera case 3, on which such base board 2 is mounted, is defined as an auxiliary device module Z and specifically is called a camera module Z. In this invention, the camera modules Y or Z can be called a crowned body.

A connector in this invention is defined as a member provided with electrical connecting elements like a connector housing, terminals, a terminal portion, an electric wire for electrical connecting. A connector according to this invention may be additionally provided with a packing, a rubber plug or a rear holder. Regarding a connector, a connector provided with male terminals is called a male connector in general and a connector provided with female terminals is called a female connector. However, in this invention, a member provided with at least a terminal and a connector housing is called a connector.

An electric wire 4 in this invention gives a generic name to a wire harness 4, a cable 4a or a core wire including a drain wire 4a′, or a conductive wire 4b without coating. Describing the cable 4a or 4a′ in this invention, the cable 4a or 4a′ is called core wire and is formed with one inductive wire 4b coated by a insulation cover 4c or enamel material or with a plurality of the inductive wires 4b.

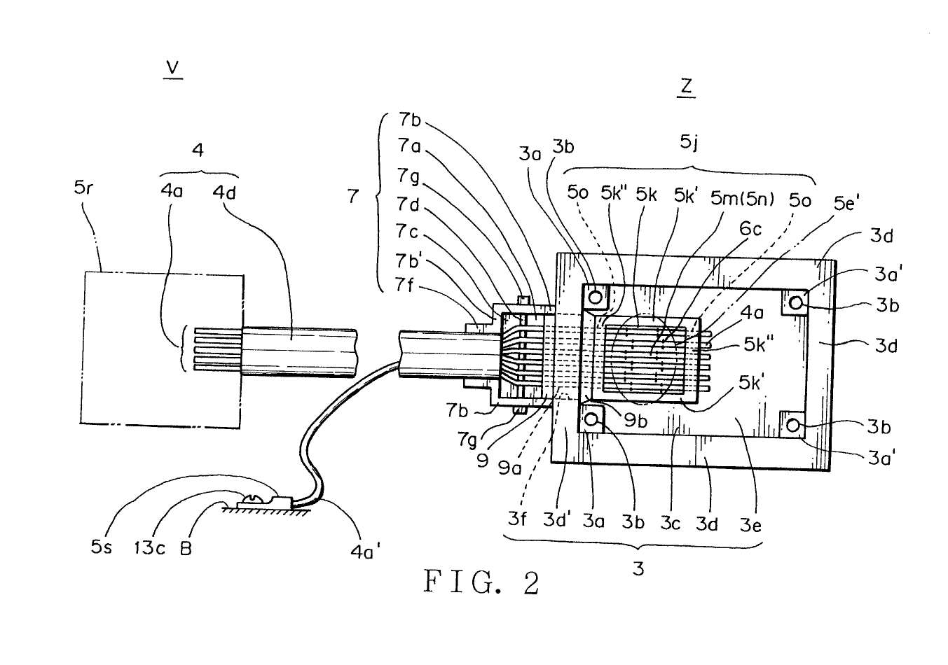

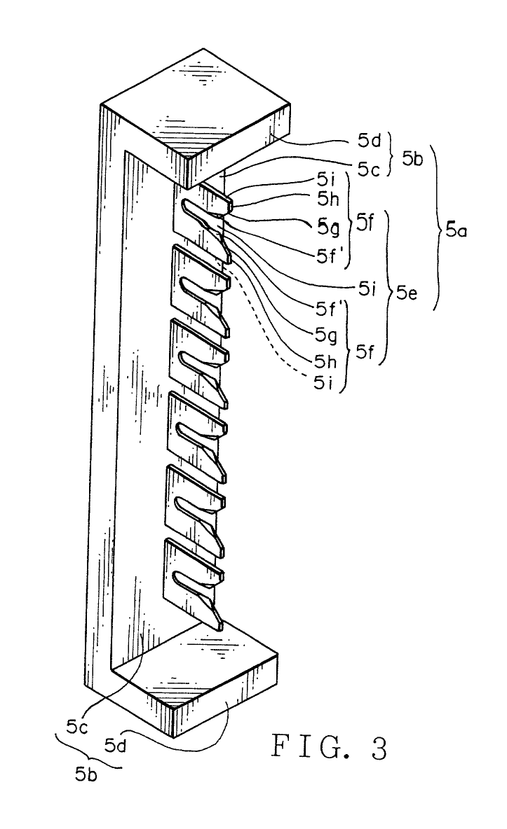

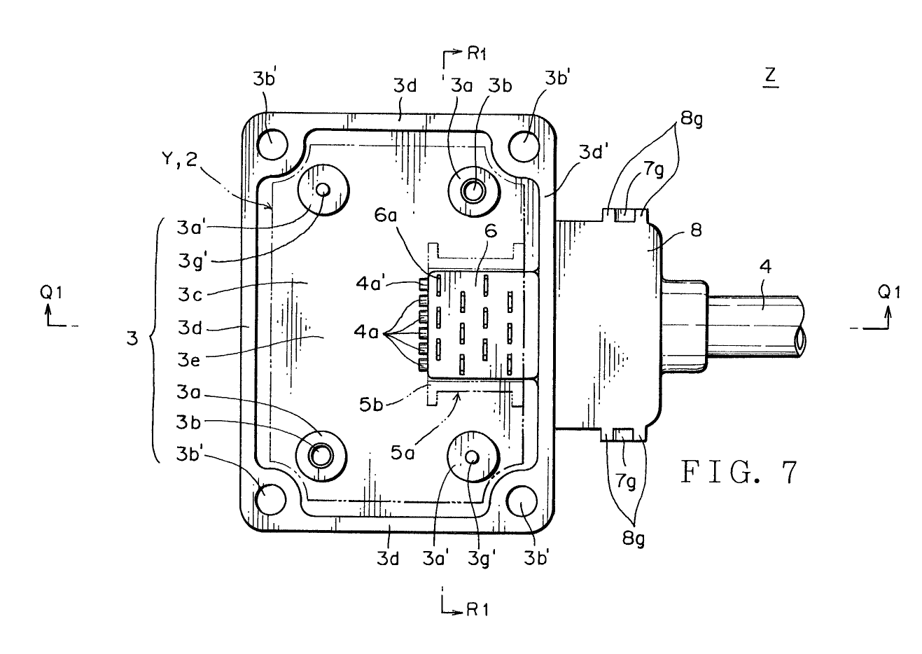

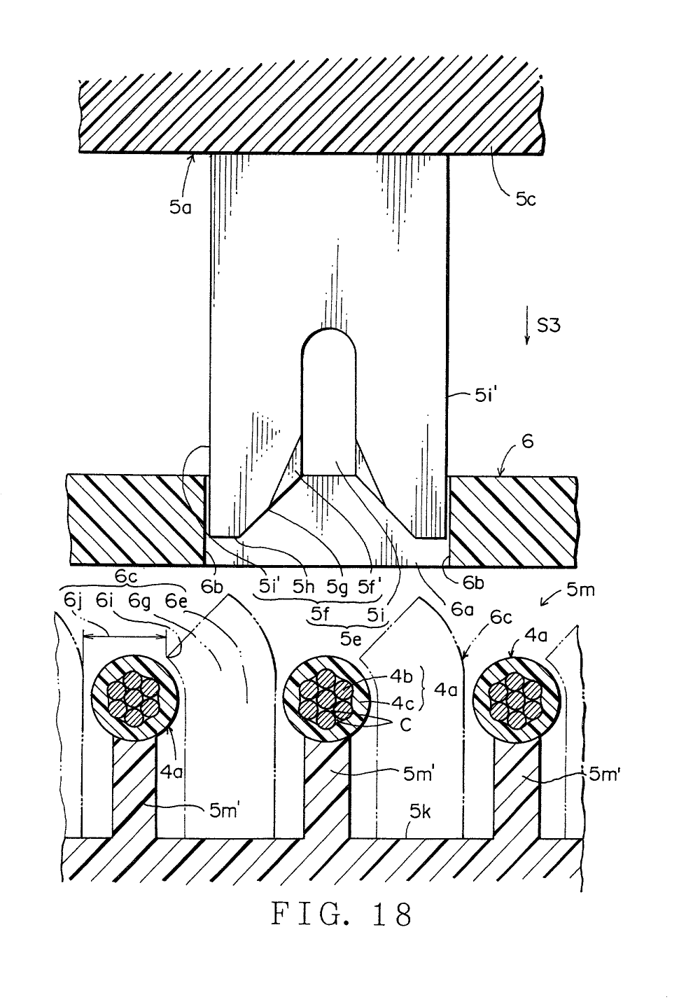

Outline of assembling operation for a camera module Z will be described with reference to FIG. 1 and 2. Expanded some specific area in FIG. 1, 2 will be described with reference to FIG. 3-6. Example of assembling operation for the other camera module Z will be described with reference to FIG. 7-17. A pressure contact type terminal 5e, an opening 6a formed on a guide cover 6, a cable 4a and related portions shown in FIG. 13 will be described in detail with reference to FIG. 18-20.

FIG. 1 is an exploded perspective view of one embodiment of an auxiliary device module Z according to the invention, showing a camera module Z as the auxiliary device module Z. FIG. 2 is a conceptual drawing to show a top view of a camera case 3 shown in FIG. 1 and connection of a wire harness 4, showing minutely a inside of a connector housing 5j shown in FIG. 1 and relative portions. FIG. 1 shows a condition of mounting a camera module Y, formed with a camera 1 including CCD with a base board 2, and a connecting case cover 8 on a specific position of the camera case 3.

The camera module Z, as shown in FIG. 1, is provided at least with a camera 1 including CCD, a base board 2 having the camera 1 and a terminals 5e and a camera case 3 for mounting the base board 2 including the camera 1 thereto.

Mounting the base board 2 to be put in the camera case 3 along mount direction S1, the terminal 5e on the base board 2 and a connecting portion 5e′ in the camera case 3, shown in FIG. 2, forms a connector 5 and the terminal 5e and the connecting portion 5e′ are electrically connected. The connector 5, as shown in FIG. 1, is provided juxtapositionaly in parallel and at even intervals with six openings 6a to perform as a guide portion 6a for guiding the terminals 5e to the connecting portion 5e′.

Thereby, the camera 1, the base board 2 and the camera case 3 are modularized and then reducing number of related elements can be done and miniaturization, weight saving and structural simplification of the module can be done. Furthermore, mounting the base board 2 provided with the camera 1 and the terminal 5e on the camera case 3 can perform assembling operation and electrically connecting operation simultaneously.

Defective units concerned while assembling a camera module Z by prior art, shown in FIG. 23, can be eliminated. According to prior art, during mounting a base board 2 including a camera 1 on a camera case 3, it is feared that a cable 4a and a drain wire 4a′ are bitten by the base board 2 and the camera case 3 and such camera module Z with bitten electric wire is judged as a defective unit by concerning open circuit in the inside of the cable 4a and the drain wire 4a′.

Abandoning such unfinished products is undesirable for terrestrial environment and wasteful on manufacturing. Then, reassembling a camera module Z to replace the wire harness 4 formed with the cable 4a, the drain wire 4a′ and a tube 4d, a clamp 10 and other elements related with an electric wire 4 is required. According to this invention, such defective units can be eliminated without such troublesome operations.

Since the connector 5 formed in the camera module Z, as shown in FIG. 1, is provided juxtapositionaly in parallel and at even intervals with guide portions 6a for guiding the terminals 5e, the terminals 5e is guided securely to the connecting portion 5e′, shown in FIG. 2, when mounting the base board 2 including the terminals 5e on the camera case 3. Thereby, electrical connection can be done easily and securely.

Thus, operators are not required to pay over attention on a connector 5 when assembling a camera module Z and connecting of a connector 5 assembled by automatic assembling machines is satisfactory. Therefore, speed-up and enhancement on assembling operation can be done and then, a low cost and low percent defective camera module Z can be provided.

Describing minutely respective portion, shown in FIG. 1, the camera 1 is provided with a camera body 1′ including CCD, a screw fixing portion 1a, a screw through hole 1b, a lens 1c, a lens area portion 1d and an other area including positioning holes 1e. Each positioning hole 1e on the camera body 1′ is provided on each four corner of the camera body 1′ to position precisely and fix the camera body 1′ and a base board body 2′. Four positioning projections corresponding to each positioning hole 1e are provided on a bottom surface of the base board body 2′, as shown in FIG. 1.

The base board 2 is provided on a bottom surface with the pressure contact type connector 5 having the connector housing 5b and the pressure contact type terminal 5e. The connector housing 5b is formed with a top wall 5c and a pair of guide portions 5d provided on the both side ends of the top wall 5c. A pressure contact type connector 5a is mounted on a required position of the base board body 2′ to form into a part of the base board 2.

FIG. 21 is an expanded perspective view of the pressure contact type connector 5a shown in FIG. 1. The pressure contact type connector 5a is provided mainly with the pressure contact type terminals 5e having the pressure contact blade 5f and the connector housing 5b. The pressure contact type connector 5a is integrated into the base board 2 and the pressure contact type terminals 5e are connected with various circuits on the base board body 2′.

Six pressure contact type terminals 5e are provided in parallel and at even intervals and in a row on the top wall 5c of the pressure contact type connector 5a. A guide portion 5d of the connector housing 5b is for a guide when the pressure contact type connector 5a is assembled with the connector housing 5j provided in the receiving section 3e of the camera case 3.

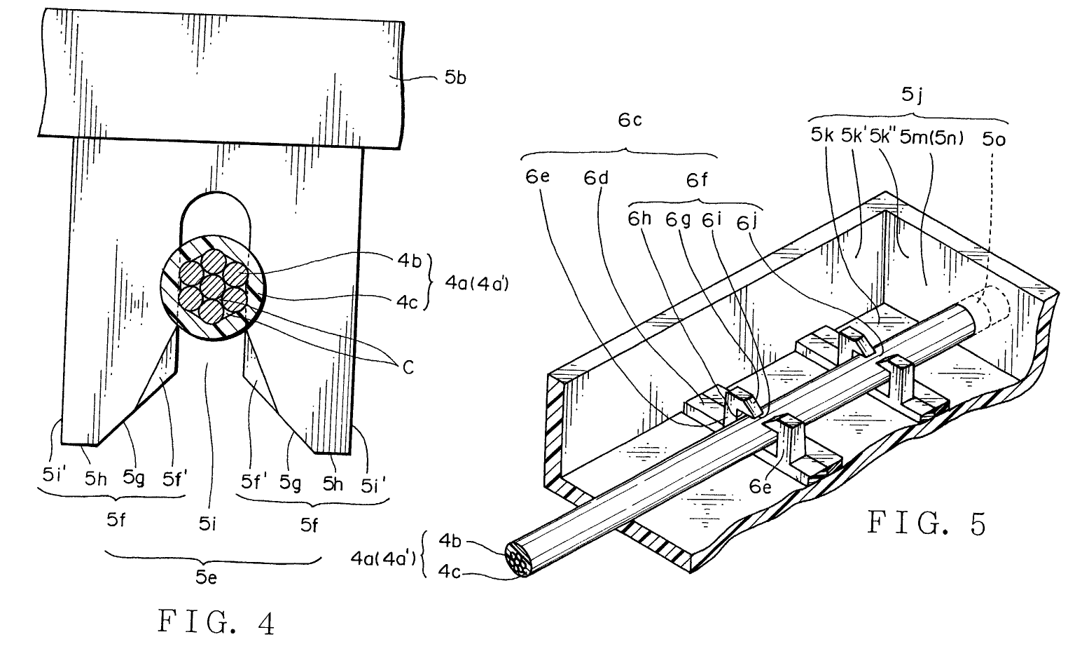

FIG. 4 is an outline drawing, showing expanded connection area of pressing the cables 4a, 4a′ into the pressure contact type terminal 5e. The cables 4a, 4a′ are formed with a plurality of conductive wires 4b having small gaps C between them and insulation covers 4c.

Soft resin or rubber may be used for materials for the insulation cover 4c or the tube 4d of the electric wire 4 such as cables 4a, 4a′. The electric wire 4 such as a wire harness 4 is provided with the cables 4a, 4a′, formed with conductive wires 4b and insulation cover 4c, and the tube 4d. The electric wire 4 is bent at any required position in use.

Therefore, a metallic wire having good conductivity and durability for repeat bending is preferable for conducting wire 4b material. In this invention, bundled plural conductive wires 4b is a good core wire on strength to be twisted temperately for bending. For improving surface insulation of the conductive wires 4b made with metallic wires, enamel coated conductive wires 4b may be used for the electric wire 4 such as the wire harness 4.

Insulation material having durability for repeat bending, as mentioned above, is preferable for insulation cover 4c to protect the conductive wire 4b. For such material, synthetic resin, soft resin, rubber or mixture with them may be used for the insulation cover 4c of the electric wire 4 such as the harness 4.

Describing minutely the camera module Z shown in FIG. 1 and 2, the terminal 5e means the pressure contact type terminal 5e and the connecting portion 5e′ is provided with the cable 4a and the drain wire 4a′ and the base board 2 is provided with the pressure contact type connector 5a including the pressure contact type terminals 5e. The camera case 3 is provided in a receiving section 5m with the connector housing 5j including the cable 4a and the drain wire 4a′ inside.

Fitting the base board 2 provided with the camera 1 and the pressure contact type connector 5a into the camera case 3, the cables 4a and the drain wires 4a′ are connected by pressure contacting to form into the connector 5. The guide portion 6a is provided with a plurality of opening 6a. At least one pressure contact type terminal 5e of plural pressure contact type terminals 5e is connected by pressure contacting with plural cables 4a and drain wires 4a′ corresponding to respective pressure contact type terminal 5e to be guided by the openings 6a. Thus, electrical connection can be done during assembling operation by pressure-contact connecting specifically with the pressure contact type terminals 5e.

Describing minutely a shape of the pressure contact type terminal 5e with reference to FIG. 3 and 4, slant portions 5g are formed to face each other so that two pressure contact blades 5f are aligned in parallel and then the pressure contact type terminal 5e is formed with a couple of the pressure contact blades 5f. The pressure contact blade 5f is formed in an opening area for inserting the cables 4a, 4a′ with a couple of the slant portions 5g provided with blade portions 5f′ having oblique sharp-edged shape.

The pressure contact type terminal 5e is formed in the center area with a pressure contact slit 5i dimensioned narrower than diameters of the cables 4a, 4a′ to receive the conductive wires 4b of the cables 4a, 4a′ and wider not to dig into the bundled conductive wires 4b over requirement or cut a circuit. The pressure contact slit 5i is formed into U-shape. A side edge portion 5i′ is formed in parallel with the pressure contact slit 5i. The shape of the pressure contact type terminal as mentioned above is a general shape. However, in this invention, other shape may be effective.

The pressure contact type terminal 5e is formed with an edge portion 5h to prevent an operator hand hurt by a sharp edge of the pressure contact slit 5f when assembling the camera module Y by combining the camera 1 and the base board 2 or fitting the camera module Y into the camera case 3. However, the edge portion 5h may be formed into sharp edge shape depending on pressure contact terminal size or shape or place in use.

The pressure contact type terminal 5e is used to connect electrically with the conductive wire 4b as a core wire protected with the insulation cover 4c made of resin, rubber, mixture with them or enamel. Pressure contacting the cables 4a, 4a′, formed with a plurality of conductive wires 4b protected with the insulation cover 4c, with the pressure contact type terminal 5e, shearing the insulation cover 4c and contacting the conductive wire 4b are done simultaneously.

Describing minutely action of pressure contact connecting the conductive wire 4b with the pressure contact blade 5f of pressure contact type terminal 5e, when pressing the pressure contact blade 5f formed on the pressure contact terminal 5e to the cables 4a, 4a′ protected with the insulation cover 4c, the insulation cover 4c, made of resin or rubber or the like, of the cables 4a, 4a′and the insulation cover 4c, made of enamel, coating with thin thickness around the conductive wire 4b are sheared firstly.

Pressing the terminal more, the pressure contact slit 5i, formed in the center area of the pressure contact type terminal 5e, contacts with the internal conductive wire 4b of the cables 4a, 4a′, shearing more the insulation cover 4c. Therefore, shearing the insulation cover 4c and contacting the conductive wire 4b are done simultaneously.

Thus, contacting the U-shape pressure contact slit 5i, provided with the pressure contact blade 5f, with the internal conductive wire 4b of the cables 4a, 4a′ or the enamel coated conductive wire 4b can give electrically connecting condition. In other words, pressure contacting the pressure contact blade 5f, formed on the pressure contact type terminal 5e, with the conductive wire 4b of the cables 4a, 4a′ or the enamel coated conductive wire 4b enables electrical connection.

Since operation of assembling the base board 2, mounted with the camera 1 and the pressure contact type connector 5a as mentioned above, and the camera case 3 and operation of pressure contact connecting as mentioned above can be done simultaneously, electrical connecting can be done by assembling the base board 2 with the camera 1 and the camera case 3.

Regarding an auxiliary device module by prior art, the operation of pressure contact connecting securely a pressure contact type terminal 5e with the cables 4a, 4a′ requires to pay much attention. A camera module Z failed in continuity test after operating pressure contact connection is treated as a defective product.

If pressure contact connection is applied again on the same position of the cables 4a, 4a′ which had be sheared once by a pressure contact type terminal 5e, the second electrical disconnection on the position is concerned. Therefore, the cables 4a, 4a′ applied pressure contact connection must be replaced or the other position of the electric wire instead of the position applied pressure contact connection previously may be connected with a pressure contact type terminal.

However, in a module by this invention, the connector 5a formed in the camera module Z is provided with openings 6a to guide a pressure contact type terminal 5e and then when fitting a base board 2 mounted with the pressure contact type terminals 5e into the camera case 3, electrical connection can be done by guiding securely the pressure contact type terminals 5e on the cables 4a, 4a′ in the connector housing 5j. Therefore, failed products mentioned above can be reduced and product yield can be improved.

Describing in detail, the connector housing 5j is provided juxtapositionaly in parallel and at even intervals with a plurality of openings 6a for guiding and at least one pressure contact type terminal 5e in a plurality of the pressure contact type terminals 5e corresponding to the openings is connected with the conductive wires 4b of the electric wires 4a, 4a′ such as the cable 4a, 4a′, corresponding to the pressure contact terminals 5e to be guided by the openings 6a.

When fitting the base board 2 mounted with the pressure contact type terminals 5e into the camera case 3, the pressure contact slit 5i formed in the pressure contact type terminal 5e is guided securely to pressure-contact with the conductive wires 4b of the electric wires 4a, 4a′, such as the cables 4a, 4a′, in the receiving section 5m of the connector housing 5j and then electrical connection can be done securely. Electrical connecting can be done by assembling the camera module Y with the base board 2 and the camera case 3.

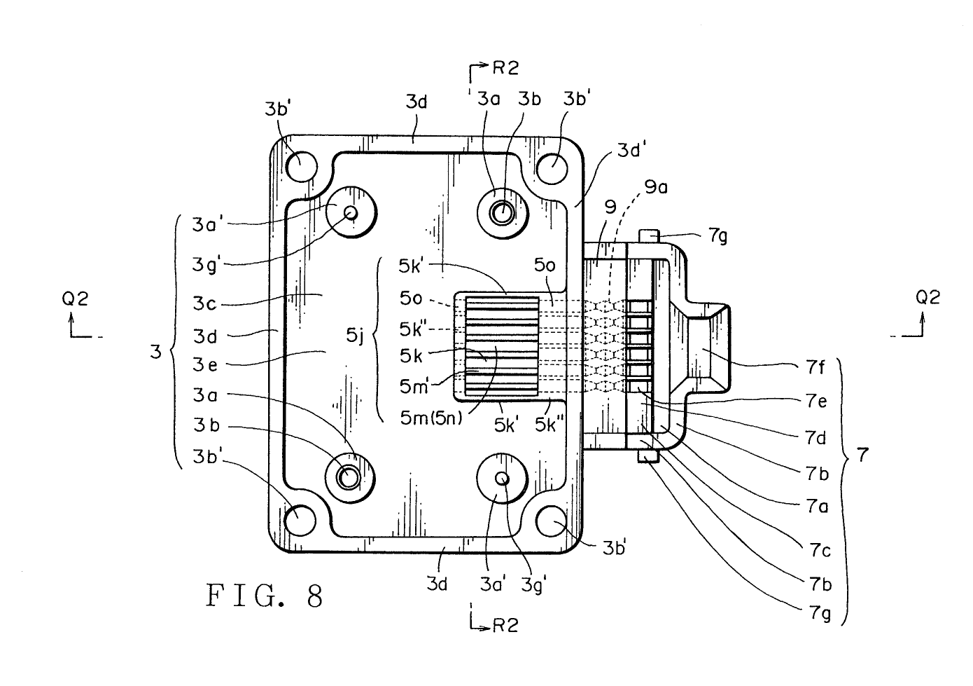

Describing simply a terminal, terminals are classified into a pressure contact type terminal and a crimp contact type terminal. Regarding the pressure contact type terminal 5e, as mentioned above with reference to FIG. 8, pressure contacting the blade portion 5f′, formed on the pressure contact blade 5f of the pressure contact type terminal 5e, with the electric wire 4 such as the cables 4a, 4a′ formed with the conductive wires 4b, protected by the insulation cover 4c, shearing the insulation cover 4c and connecting with the conductive wires 4b can be done simultaneously. A terminal provided with U-shape contact with the pressure contact slit 5i is a typical example. The pressure contact slit 5i can be called simply a slit.

On the other hand, a crimp contact type terminal is provided with a barrel portion, plastic deformed by a crimping tool to connect a electric wire mechanically and electrically. Generally, the barrel portion includes a wire barrel, for crimp contacting with a conductive wire at insulation cover removed area, and a insulation barrel for crimp contacting an insulation cover area of an electric wire. The wire barrel is classified into a closed barrel and an open barrel.

Preferably, in this invention, the pressure contact type connector 5a mounted on the base board 2 as shown in FIG. 1 may be replaced by a male type or female type connector with crimp contact type terminals and a portion including cables 4a, 4a′ in the connector housing 5j may be replaced by a female type or male type connector which can be connected correspondingly with the above connector and inserting correspondingly connecting terminals to the above terminals into this connector is effective.

Furthermore, portions of the cables 4a, 4a′ mounted in the connector housing 5j may be replaced by bus bars and ends of the bus bars may be formed into required terminal shape to connect with connector elements on the base board. Assuming to meet the objects of this invention, any type terminals and connectors can be used.

Various kind of electric circuit elements, such as bus bars, terminals and electric wires for connecting with electric wiring are provided and retained on the base board body 2′. The base board 2 is an insulating plate to retain such electric circuits and to prevent electrical contacting between each electric circuits and can be called “insulated board”.

Describing a material to form the base board 2, synthetic resin such as thermosetting resin or thermoplastic resin is preferable for good formability and good performance to insulate various electric elements such as bus bars or terminals. Any above synthetic resin with low water absorbing property is preferable on dimensional stability, volume productivity and stable electric performance.

The bus bar is provided with conductive sheet metal to branch plural electric circuits and electrical circuit network with many electric contact pieces. Provided bus bars are a bus bar body, a bus bar for connectors, a bus bar for relay, a bus bar for fuse, a bus bar for power supply or the like. The bus bar for fuse is called a clamp hold type terminal or a tuning fork shape terminal by the formed shape. The bus bars may be provided with junction terminals if required.

Copper-base metal such as bronze or copper alloy and aluminum alloy may be listed for materials for the pressure contact terminal 5e or bus bars used in this invention. Electrical conductive metal or any kind of materials having good electrical conductivity may be used for the pressure contact terminal 5e or bus bars used in this invention.

Applying surface protecting process such as metal plating on above material for enhancement of corrosion resistance is preferable. If the performance can be kept enough under normal working condition without surface treatment, such surface protecting process may not be applied preferably in a viewpoint of cost.

The camera case 3, shown in FIG. 1 and 2, is formed with a bottom wall 3c and side walls 3d, 3d′ standing around the bottom wall to provide a receiving section 3e. The camera case 3, as shown in FIG. 1, 2 and 6, is provided with a mat seal 9 integrally molded in the side wall 3d′ to enhance sealing performance. The mat seal 9 is provided with through holes 9a for inserting cables 4a and a drain wire a′. The cables 4a, 4a′ are led from outside into a inside of the camera case 3 through the mat seal 9.

The form of the mat seal 9 will be described in detail with reference to FIG. 2. The mat seal 9 is integrally molded from a round portion of a through hole 3f formed in the side wall 3d′ of the camera case 3 to a side wall 5k″ forming an end portion of the connector housing 5j. The mat seal 9 is provided on a side of receiving section 3e of the camera case 3 with a locking portion 9b to prevent dropping through from the through hole 3f of the camera case 3. The locking portion 9b formed on the mat seal 9 is fixed in the camera case 3 to be integrally molded and sandwiched between an inner surface of the side wall 3d′ of the camera case 3 and an outer surface of the side wall 5″ of the connector housing 5j.

Describing manufacturing method of the mat seal 9, firstly the camera case 3 is manufactured by aluminum casting mold method. Or, the camera case 3 is formed with synthetic resin which can be injection molded and has thermoplastic property. After pouring synthetic polymer, such as granular silicon, into the through hole 3f and round area of the camera case 3, the mat seal 9 is formed into a required shape to solidify the polymer.

In the process, after fixing the cables 4a, 4a′ in a through hole 5o of the connector housing 5j formed in the receiving section 3e of the camera case 3, the cables 4a, 4a′ and the mat seal 9 may be integrally molded. On the other way, molding the mat seal 9 to form the through holes 9a in preprocess, the cables 4a, 4a′ may be inserted into the through holes 9a formed in the mat seal 9.

Thus, the mat seal 9 is formed integrally between the side wall 3d′ of the camera case 3 and a side wall 5k″ forming an end portion of the connector housing 5j. And the cables 4a, 4a′ sealed by the mat seal 9 are inserted from a connecting case 7 toward the receiving section 5m of the connector housing 5j. The through hole 3f formed in the side wall 3d′ of the camera case 3 is sealed by the mat seal 9.

Providing the mat seal 9 as mentioned above, electric wires such as the cables 4a and the drain wire 4a′ can be inserted from the outside into the inside of the camera case 3 and penetration of contaminants such as water or dust into the inside of the camera case 3 can be protected.

The camera case 3 is provided on the inner four corners with screw fixing bodies 3a, 3a′ to fix the camera module Y including the camera 1 and the base board 2, as shown in FIG. 1, 2. Each screw fixing body 3a, 3a′ is provided with a female tapped hole 3b. One female tapped hole 3b is formed in each screw fixing body 3a, 3a′ provided on the camera case 3 and total 4 screw holes are provided on the camera case.

Location of the four female screw holes 3 will be described with reference to FIG. 1. Two screw fixing bodies 3a on a front side are placed higher than positions of two fixing bodies 3a′ on a rear side. Therefore, Positions of the female tapped holes 3b of two screw fixing bodies 3a provided on the front side are placed higher than positions of the female tapped holes 3b of two screw fixing bodies 3a′ provided on the rear side.

The height position difference of the screw holes, as showing the camera module Y mounted with the camera 1 and the base board 2 in FIG. 1, is for shifted height position of screw fixing bodies 1a on the camera 1 against height position of screw bodies 2a on the base board 2 to assemble combination of the camera 1 and the base board 2 into the camera case.

The camera body 1′ is provided with two screw fixing bodies 1a and the base board body 2′ is provided with two screw fixing bodies 2a and then combining the camera 1 and the base board 2 gives total four screw fixing bodies 1a, 2a provided on the camera module Y. When combining the camera and the base board, respective screw fixing bodies 1a, 2a will not have the same height. Therefore, as shown in FIG. 1, height difference between the screw fixing bodies 3a, 3a′ of the camera case 3 is given to adjust the height position of the screw fixing bodies 1a, 2a of the camera module Y.

Preferably, the camera case 3, as showing one embodiment of the invention, may be formed with aluminum alloy by aluminum die cast to be lightweight and have many advantages on mechanical strength, anti-corrosion, manufacturability and productivity. Since CCD camera mounted on the outside of a car is exposed to the weather, anti-corrosion material is very important. Small specific gravity material is preferable to save weight in a car. For a material of the camera case 3 used for above application, aluminum alloy or synthetic resin which can be injection molded and has thermoplastic property may be preferable to be good for mass production.

The camera case 3, as shown in FIG. 1, 2, is provide in the receiving section 3e with the connector housing 5j. A guide cover 6 is provided on a top surface of the connector housing 5j to be removable by press-fitting structure or the like.

The opening 6a, performing as guide portion 6a, is formed on a top surface of the guide cover 6 in a position corresponding to the above pressure contact type terminal 5e. Some numbers, for example six, of the openings 6a are provided at even intervals in a row to be the numbers as same as number of the pressure contact type terminals 5e. The opening 6a is formed into a rectangular shape throughhole corresponding to the pressure contact type terminal 5e shape.

Thus, as shown in FIG. 1, providing a pair of the guide portions 5d on the both side of a top wall 5c of the pressure contact type connector 5a and providing the opening 6a with the same numbers and the same alignment as the corresponded pressure contact type terminals 5e, respective pressure contact type terminals 5e can be led into corresponded openings 6a. Therefore, each pressure contact type terminal 5e is satisfactorily connected correspondingly with respective cable 4a, 4a′ by pressure contacting.

The connector housing 5j, as shown in FIG. 2, is formed integrally with the camera case 3 in the receiving section 3e of the camera case 3. The connector housing 5j can be provided as a separated element for the camera case 3. Preferably, the connector housing 5j may be formed integrally with the camera case 3 to reduce number of elements and cost. The connector housing 5j may be formed into a size corresponding to a shape of the pressure contact type connector 5a, shown in FIG. 1 and 3. The connector housing, as shown in FIG. 2 and 5, is provided with a receiving section 5m formed with a bottom wall 5k and side walls 5k′, 5k″ on all sides.

The cables 4a and the drain wire, as shown in FIG. 2 and 5, is installed in the receiving section 5m of the connector housing 5j. Respective cables 4a, 4a′ including the drain wire 4a′ is held by a wire fixing portion 6c provided on the bottom wall 5k of the connector housing 5j. The cables 4a, 4a′ are installed at even intervals in a row in the receiving section 5m of the connector housing 5j.

An opening portion 5n is provided on a top side of the receiving section 5m of the connector housing 5j to connect the pressure contact type terminals 5e, mounted in the pressure contact type connector 5a, with each cable 4a, 4a′ installed in the receiving section 5m of the connector housing 5j. The guide cover 6 having the openings 6a is mounted into the opening portion 5n by press fitting or the other method as shown in FIG. 1.

The wire fixing portions 6c are provided in stagger on the front-and-rear and right-and-left side of each cable 4a, 4a′. FIG. 5 is a partial expanded perspective view on a round area of a connecting portion 5e′ shown in FIG. 2, showing mounting the cables 4a, 4a′ in the wire fixing portion 6c. The connecting portion 5e′ is a portion corresponding to the pressure contact type connector 5a including the pressure contact type terminals 5e.

Providing adjacent wire fixing portions 6c of each other in stagger in the receiving section 5m of the connector housing 5j, as shown in FIG. 2, the receiving section 5m of the connector housing 5j can be sized smaller. Therefore, miniaturized and weight saved auxiliary device module Z, such as a camera module Z, can be provided by miniaturizing the camera case 3.

At least two wire fixing portions 6c for fixing the cables 4a, 4a′ in the receiving section 5m of the connector housing 5j are provided for one cable 4a, 4a′, as shown in FIG. 2 and 5. A pair of wire fixing portions 6c, as shown in FIG. 5, is provided on the cable 4a, 4a′. Two wire fixing portions 6c are provide along the length of the cable 4a, 4a′ and total twelve wire fixing portions are provided in the receiving section 5m of the connector housing 5j.

Therefore, the cables 4a, 4a′ are fixed in required position during operation of pressure contact connecting and when the pressure contact blade 5f of the pressure contact type terminal 5e, shown in FIG. 4, is starting to shear the cables 4a, 4a′, the cables 4a, 4a′ can not flee from pressing force by the pressure contact blade 5f (pressure contact force) and can catch the pressure contact force securely. Thus, pressure contact connection can be done satisfactorily.

Preferably, a through hole So, formed in the side wall 5k″ of the connector housing 5j shown in FIG. 2 and 5, may perform to fix the cables 4a, 4a′ to fix the cables 4a, 4a′ more securely, adding to fixed position by above wire fixing portions 6c.

A shape of the wire fixing portion 6c, shown in FIG. 2 and 5, will be described herein. The wire fixing portion 6c is formed into hook shape as shown in FIG. 5. Describing in detail, the wire fixing portion 6c has gate shape formed with a pair of inverted L-shape portions.

The wire fixing portion 6c is provide with a base plate 6d, a pillar portion 6e and locking portion 6f. The pillar portion 6e of the wire fixing portion 6c extends upwardly from the base plate 6d mounted on the bottom wall 5k of the connector housing 5j and the locking portion 6f for preventing the cables 4a, 4a′ coming out is formed on a top of the wire fixing portion 6c.

The locking portion 6f is formed on a top with a slant portion 6g to lead the cables 4a, 4a′ easily into the wire fixing portion 6c when installing the cables 4a, 4a′ in the wire fixing portion 6c. However, the locking portion 6f is formed on a bottom from an end edge portion 6i of the locking portion 6f toward the pillar portion 6e with a parallel portion 6h in parallel with the base plate 6d to prevent the cables 4a, 4a′ coming out.

A gap distance 6j between one end edge portion 6i and the other end edge portion 6i of the wire fixing portion 6c, clamping the cables 4a, 4a′, is dimensioned to be smaller than a diameter of the cable 4a, 4a′ for preventing the cables 4a, 4a′ coming out from the wire fixing portion 6c and also to fit the cable 4a, 4a′ easily into the wire fixing portion 6c.

The length of the pillar portion 6e from the base plate 6d to the parallel portion 6h is dimensioned to be slightly smaller than a diameter of the cable 4a, 4a′ to clamp the cables 4a, 4a′ between the locking portion 6f and the base plate 6d, provided in the wire fixing portion 6c, for preventing the cables 4a, 4a′ moved easily by pressure contact force loaded on the pressure contact blade 5f of the pressure contact type terminal 5e during pressure contacting connection.

Some clearance between the cables 4a, 4a′ and the pressure contact blade 5f is required to accept error of positioning each elements or position moving during pressure contact connection. Therefore, the length between one inner surface and the other inner surface of the pillar portion 6e, provided in the wire fixing portion 6c is dimensioned to be longer than a diameter of the cable 4a, 4a′ as allowance for positioning error during pressure contact connection.

If the cables 4a, 4a′ are fixed during operation of pressure contact connecting, as mentioned above, when the pressure contact blade 5f of the pressure contact type terminal 5e is starting to shear the cables 4a, 4a′, the cables 4a, 4a′ can accept the pressure contact force on the pressure contact blade 5f. Then, pressure contact connection can be done satisfactorily.

The wire fixing portion 6c may be formed with synthetic resin which can be injection molded and has thermoplastic property. The wire fixing portion 6c can be integrally molded with the connector housing 5j by the same material or may be molded as separated elements by each different material and be mounted in the receiving section 5m of the connector housing 5j.

The cables 4a, 4a′, connected by pressure contact, are bundled by the tube 4d to form into the wire harness 4 which is connected with specific portions in a car. The wire harness may be formed with a dummy wire added on the cables 4a, 4a′ to be connected with other electric circuits if required.

The wire harness 4, as shown in FIG. 2, connects the camera case 3 and the non-waterproof connector 5r installed in the inside-of-car V. The drain wire 4a′, branched from a middle point of the wire harness 4, is provided at one end with a terminal 5s and the terminal 5s is fixed on a frame of a car body B with a screw 13. The drain wire 4a′ performs earth ground. Thus, the base board 2 including the camera 1, the wire harness 4, the non-waterproof connector 5r installed in the inside-of-car V and the drain wire 4a′ are connected electrically to each other.

The connecting case 7, as shown in FIG. 1, 2 and 6, is provided on the sidewall 3d′ of the camera case 3. The connecting case 7 is provided to prevent over loading of bending force on the wire harness 4 and protect the cables 4a, 4a′ coming out from the tube 4d of the wire harness 4 and place the cables 4a, 4a′ coming out from the tube 4d of the wire harness 4 in a row.

The connecting case 7 may be formed integrally with the camera case 3 or may be mounted on the camera case 3 as a separated element from the camera case 3. Preferably, the connecting case 7 may be formed integrally with the camera case 3 to reduce number of elements.

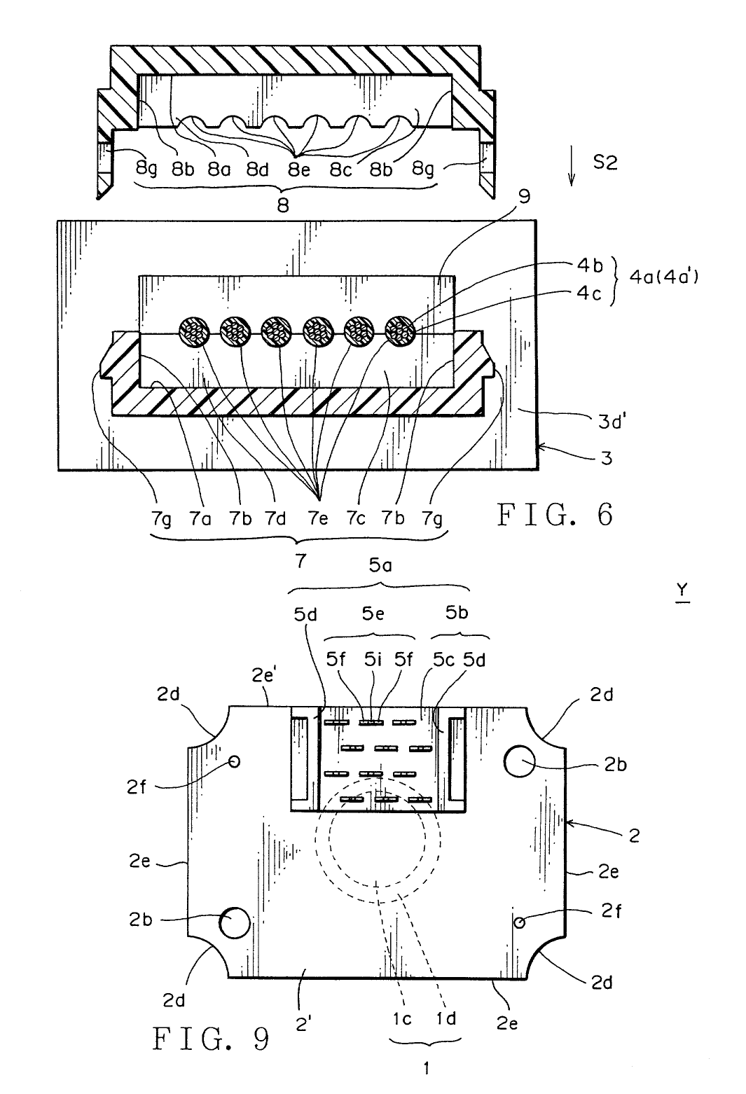

The connecting case 7 is provided with a receiving section 7c formed with a bottom wall 7a and side walls 7b, 7b′ around the bottom wall 7a . The connecting case 7 is provided in the receiving section 7c with a guide plate 7d to place the cables 4a, 4a′ in parallel and in a row. The number of guide grooves 7e as the same number , for example 6, of the cables 4a, 4a′, as shown in FIG. 6, is provided at even intervals on a top side of the guide plate 7d to fix the cables 4a, 4a′ in a row. A wire guide portion 7f for guiding the wire harness 4 is formed along a fitting direction to the wire harness 4 and extending from the side wall 7b′, as shown in FIG. 1 and 2, to prevent over loading of bending force on the wire harness 4.

A connecting case cover 8 is provide to be mounted correspondingly on the connecting case 7, as shown in FIG. 1 and 6. FIG. 6 is a sectional view taken along the line P-P of FIG. 1 showing the connecting case 7 and the connecting case cover 8. The connecting case cover 8 is provided with a receiving section 8c formed with a top wall 8a and side walls 8b , 8b′ around the top wall 8a.

A guide plate 8d, having guide grooves 8e corresponding to the guide grooves 7e formed in the guide plate 7d of the connecting case 7, is provided in the connecting case cover 8. Describing in detail, The guide plate 8d for placing the cables 4a, 4a′ in parallel and in a row is provided in the receiving section 8c of the connecting case cover 8.

The number of guide grooves 8e as the same number, for example 6, of the cables 4a, 4a′ is provided at even intervals on a bottom side of the guide plate 8d to fix the cables 4a, 4a′ in a row. A wire guide portion 8f for guiding the wire harness 4 is formed along a fitting direction to the wire harness 4 and extending from the side wall 8b ′, as shown in FIG. 1, to prevent over loading of bending force on the wire harness 4.

The guide grooves 7e, 8e for fixing the cables 4a, 4a′separated from the wire harness 4 are provided at even intervals on the connecting case 7 and corresponded connecting case cover 8. Fixing the connecting case cover 8 on the connecting case 7 from mount direction S2 shown in FIG. 6, each cable 4a, 4a′ is clamped and fixed by the guide grooves 7e of the connecting case 7 and the guide grooves 7e of the connecting case cover 8. The guide plate 7d, 8d having guide grooves 7e, 8e may be called a rib.

Fixing the connecting case cover 8 on the connecting case 7, the wire guide portion 7f formed on the connecting case 7 and the wire guide portion 8f formed on the connecting case cover 8 are combined to prevent over loading of bending force on the wire harness 4.

Since the wire guide portions 7f, 8f for the electric wire 4 such as the wire harness 4, are provided on the connecting case 7 and the corresponded connecting case cover 8 as shown in FIG. 1 and 2, the cables 4a, 4a′ can not be bent with a sharp corner on a mounting area of camera case 3 and prevented over loading of bending force on them, during separating the wire harness 4 or handling the assembled camera module Z.

The connecting case 7 and the connecting case cover 8 are fixed securely by a pair of locking portions 7g provided outside of the side walls 7b of the connecting case 7 and a pair of engaging portions 8g provided outside of the side walls 8b of the connecting case cover corresponding to the locking portions 7g. Fitting the convex shape locking portion 7g into the engaging portions 8g provided with engaging openings corresponding to the locking portions, the connecting case 7 and the connecting case cover 8 are fixed.

The connecting case cover 8 is made of synthetic resin by injection molding. As shown in this embodiment, forming with synthetic resin which can be injection molded and has thermoplastic property is preferable for mass production. Not only injection molding but also the other manufacturing method can be used. Forming not only the connecting case cover 8 but also the camera case 3 integrally formed with the connecting case 7 by synthetic resin by injection molding. As shown in this embodiment, forming with synthetic resin which can be injection molded and has thermoplastic property is good mass productivity for any complicated shape.

A molded body with synthetic resin may have good spring back force potentially inside. If the connecting case cover 8 is formed by synthetic resin molding, during fitting the engaging portions 8g of the connecting case cover 8 into the locking portion 7g of the connecting case 7 shown in FIG. 1 and 6, the engaging portion 8g is elastically deformed temperately and the locking portion 7g goes easily into the engaging opening of the engaging portion 8g and then the connecting case 7 and the connecting case cover 8 are fixed rapidly and easily.

As synthetic resin which can be injection molded and has thermoplastic property, polybutylene terephthalate (PBT for short), acrylonitrile butadiene styrene (ABS for short) and polypropylene (PP for short) are given examples. The connecting case cover 8 used in this invention is made of polybutylene terephthalate (PBT) as an example which has good stability on dimension and strength and good electrical characteristics. PBT-HO1 is given an example as PBT materials.

Regarding manufacturing method of the auxiliary device module Z such as the camera module Z, an example for assembling process and method of the camera module Z will be described with reference to FIG. 1-6.

Terminals such as various pressure contact type terminals 5e and various bus bars are manufactured to be respective required shapes by punching and bending process with metals for terminals. In other process, the base board 2 is formed with thermosetting resin or the like and the connector housing 5b is injection molded with thermoplastic resin. The various bus bar, the connector housing provided with the pressure contact type terminals 5e and other various electric elements are mounted on the base board 2.

The camera 1 provided with the lens 1c, the lens area portion 1d and camera body 1′ shown in FIG. 2 is prepared in preprocess. The camera module Y is prepared to mount the camera 1, the pressure contact type connector 5a provided with the pressure contact type terminals 5e and other various electric circuits on the base board 2 in preprocess, as shown in FIG. 1.

The camera case formed integrally with the connector housing 5j and the connecting case 7 shown in FIG. 2, the connecting case cover 8 shown in FIG. 1 and 6, the wire fixing portion 6c are molded with synthetic resin which can be injection molded and has thermoplastic property in other process. The wire fixing portion 6c may be mounted on a required position in the connector housing 5j or mat be formed integrally with the connector housing 5j by the same material.

Regarding the wire harness 4, the cables 4a and the drain wire 4a′ are prepared to come out with required length from the tube 4d by shearing the tube 4d in preprocess.

The cables 4a, 4a′ are inserted through the through hole 5o formed in the side wall 5k″ of the connector housing 5j provided in the camera case 3 and set into the wire fixing portion 6c provided in the receiving section 5m of the connector housing 5j. Each of the cables 4a, 4a′ is fixed securely in two positions by the wire fixing portion 6c.

The cables 4a, 4a′ may be fixed on the side wall 5k″ with adhesive to fix the cables 4a, 4a′, inserted through the through hole 5o provided in the side wall 5k′ of the connector housing 5j, on the side wall 5k″ securely, if required.

The cables 4a, 4a′ are also set in a row into the guide grooves 7e formed on the guide plate 7d of the connecting case 7, as shown in FIG. 1, 2 and 6. After pouring synthetic polymer, such as granular silicon, into the through hole 3f and round area of the camera case 3, the mat seal 9 is formed into a required shape to solidify the polymer.

The base board 2 having the camera 1 and the pressure contact type connector 5a, that is the camera module Y, is fit into the camera case 3. During this assembling operation, the pressure contact blades 5f of the pressure contact type terminals 5e, mounted in the pressure contact type connector 5a, shears the insulation cover 4c of the cables 4a, 4a′ fixed on the connector housing 5j and contacts with the conductive wires 4d simultaneously and then internal connecting in the camera module z is done. Thus, the base board 2 and the camera case 3 are electrically connected by the connector 5.

Specifically, connecting by the pressure contact type terminal 5e, assembling and electrical connecting can be done effectively and simultaneously in the process. In this invention, other type of female-male connector may be used. Regarding connecting by the pressure contact type terminals 5e, shearing the insulation cover 4c and connecting with conductive wire 4b can be done simultaneously, as mentioned above, and then such connecting method is effective. After stripping insulation covers of cables to make inner conductive wires come out and connecting the conductive wires with crimp type terminals in prior art, each corresponded crimp type terminals are connected. Therefore, connection by pressure contact type terminals can save labor operation compared with connection by the crimp type terminals.

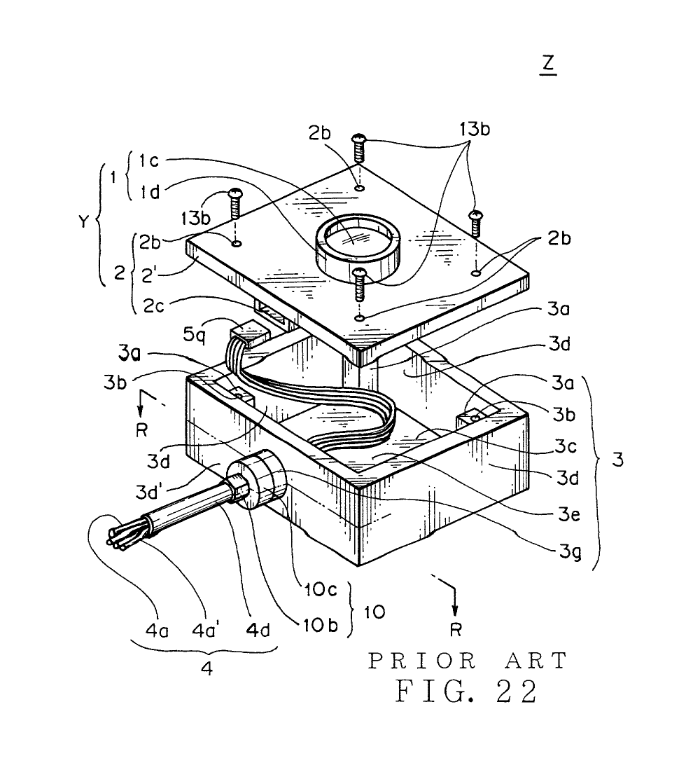

Assembling the camera module Z by such process, electrical connection can be done by fitting the base board 2 provided with the camera 1 into the camera case 3. As prior art shown in FIG. 22-24, joining the connector housing 5q provided with terminals with the cables 4a, 4a′ and inserting the connector housing into the through hole 3f of the camera case 3 and connecting the connector housing with the connector housing 2c which is provided with terminals and mounted on the base board body 2′, the base board 2 and the wire harness 4 are electrically connected. The camera module Z can be assembled by pressure contact type terminals without such operation. Thus, assembling operation by this invention can be simplified more than that by prior art and then assembling operation can be simplified and more rapid and operating efficiency can be improved.

A trouble of the camera module Z by prior art during assembling can be solved. The trouble that the cables 4a, 4a′ are bitten by a gap between the base board 2 and camera case 3 during fitting the base board 2 having the camera 1 into the camera case 3 can be prevented. In this invention, the base board 2 provided with the camera 1 and the camera case 3 are connected by the pressure contact type connector 5a and then the trouble of biting cables 4a, 4a′ is not concerned.

Specifically, during mounting the camera module Y on the camera case 3 by prior art as shown in FIG. 23, extra length portions of the cables 4a, 4a′ come out from a gap between the camera module Y and the camera case 3 and the coming out portions of the extra length of the cables 4a, 4a′ are bitten. In this invention, such trouble is not occurred.

Therefore, an operator is not required to pay over attention to prevent biting the cables 4a, 4a′ between the base board 2 and the camera case 3 during assembling the base board 2 and the camera case 3. In automatic assembling machines, the automatic assembling machines are not stopped by biting the cables 4a, 4a′ and yield down of the camera module Z in process by damaged cables by biting is not concerned.

After putting the camera module Y, shown in FIG. 1, into the camera case 3 in mount direction S1, four screws 13a are inserted into the screw through hole 1b, 2b formed in each screw fixing portion 1a, 2a. Respective screw 13a is fastened by a screwdriver into each female tapped hole 3b of each screw fixing body 3a, 3a′ provided on the four corners of the camera case 3. During the operation, pressure contact connection may be going securely. A case cover for protecting an auxiliary device such as the camera 1 may be mounted on the case 3 simultaneously, if required.

Simultaneously mounting the connecting case cover 8 on the connecting case 7 as shown in FIG. 6, the cables 4a, 4a′ are fixed securely by the guide grooves 7e formed in the guide plate 7d of the connecting case 7 and the guide grooves 8e formed in the guide plate 8d of the connecting case cover 8. Thus, the camera module Z is assembled in above process.

Other embodiment according to this invention will be described with reference to FIG. 7-20. Regarding overlapped portion of description in FIG. 1-6 on shapes and processes, detailed description will be omitted. Performances and materials related with following description on other embodiment are almost same as the performances and materials as mentioned above. Therefore, description for the performances and materials on the embodiment is omitted herein. FIG. 7 is a top view of other embodiment of an auxiliary device module Z according to this invention, showing a camera module Z as auxiliary device module Z. FIG. 8 is a top view of a camera case 3 and its surrounding areas shown in FIG. 7. FIG. 9 is a plan view of a pressure contact type connector 5a mounted on the camera case 3 shown in FIG. 7 and a base board 2 provided with a camera 1.

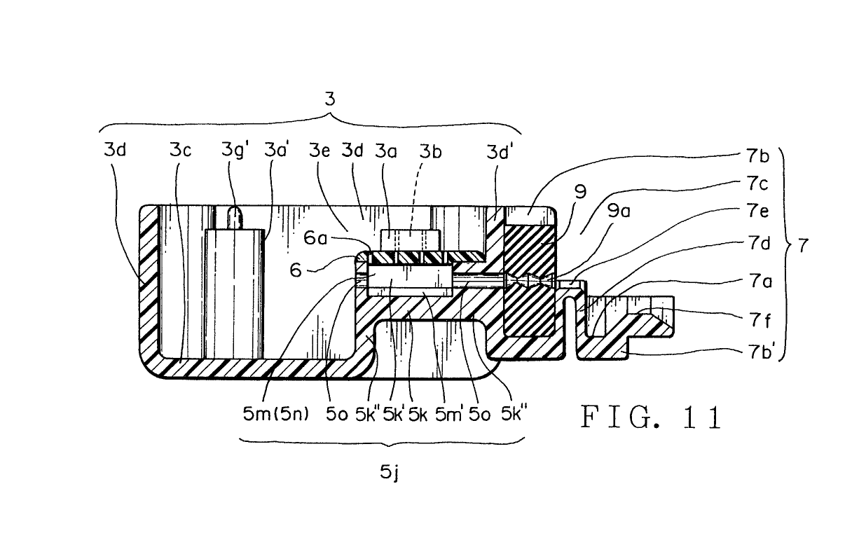

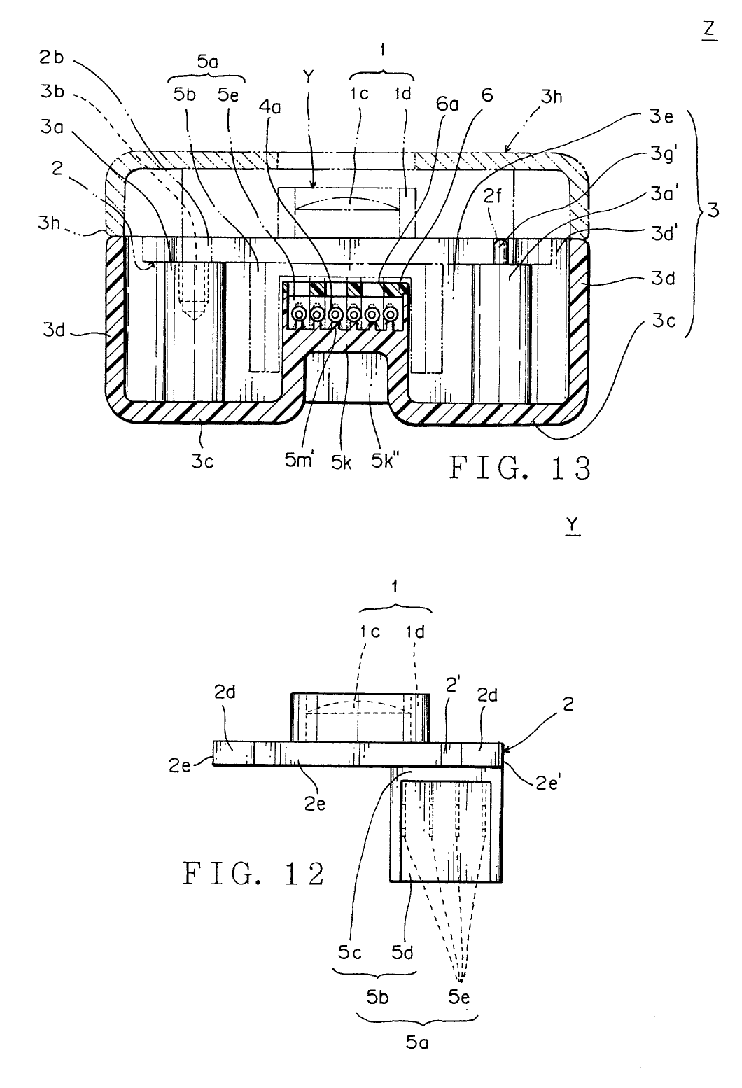

FIG. 10 is a sectional view taken along the line Q1-Q1 of the camera module Z shown in FIG. 7. FIG. 11 is a sectional view taken along the line Q2-Q2 of the camera case 3 and its surround areas shown in FIG. 8. FIG. 12 is a side view of the base board 2 provided with the camera 1 and the pressure contact type connector 5a shown in FIG. 9.

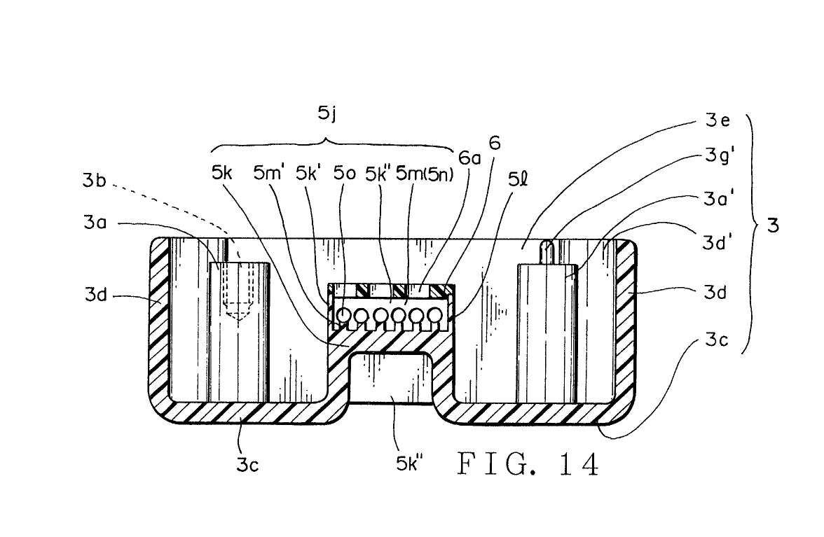

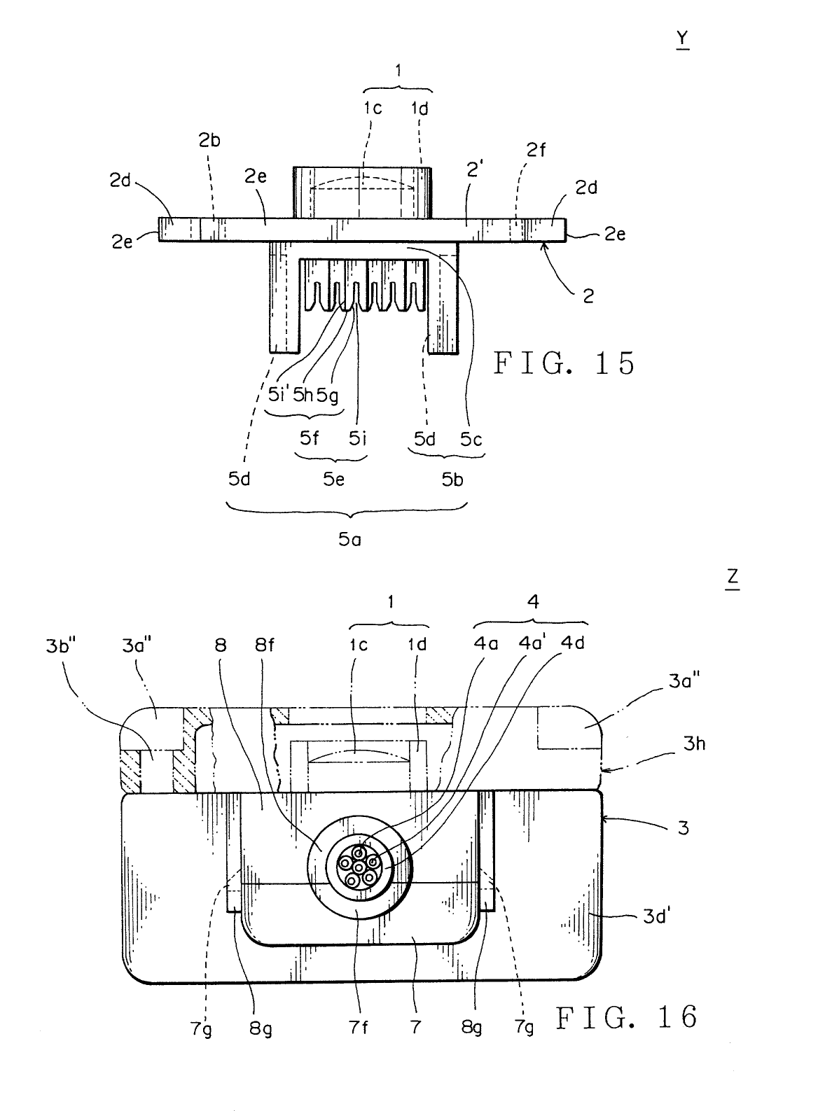

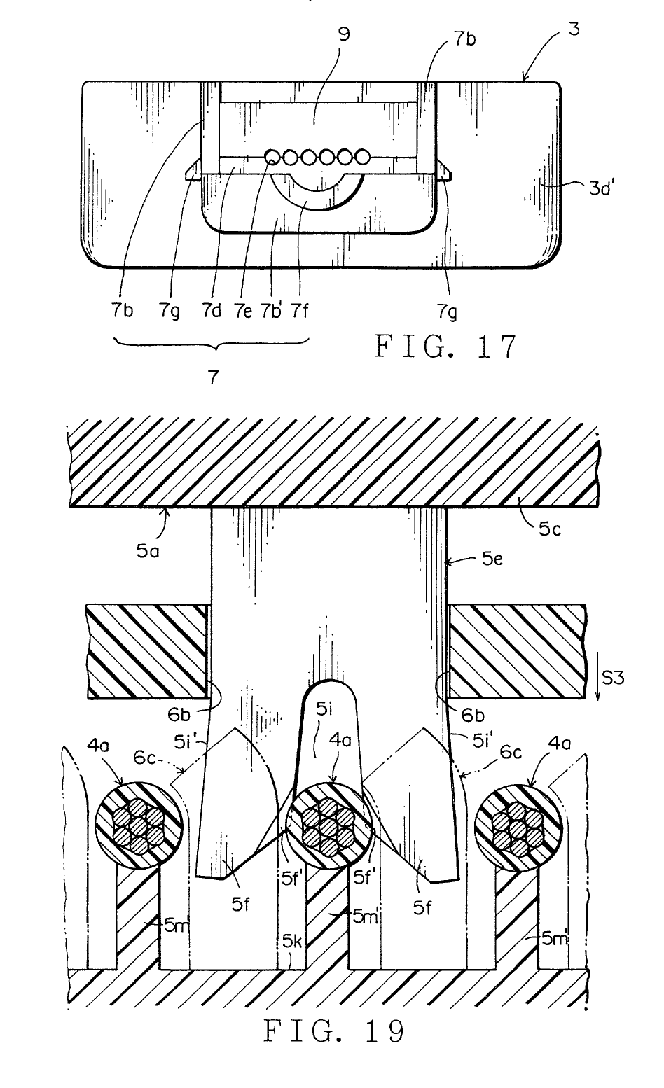

FIG. 13 is a sectional view taken along the line R1-R1 of the camera module Z shown in FIG. 7. FIG. 14 is a sectional view taken along the line R2-R2 of the camera case 3 and its surround areas shown in FIG. 8. FIG. 15 is a front view of the base board 2 provided with the camera 1 and the pressure contact type connector 5a shown in FIG. 9 and 12. FIG. 16 is a front view seeing from a side of a wire harness 4 of the camera module Z shown in FIG. 7 and 10. FIG. 17 is a front view seeing from a side of a connecting case 7 of the camera case 3 and its surround areas shown in FIG. 8 and 11.

The auxiliary device module Z of other embodiment according to this invention, as shown in FIG. 7, 8, 10 and 13, comprises a base board 2 provided with an auxiliary device 1 such as a camera 1 and a pressure contact type connector 5e, a camera case 3, cables 4a and a drain wire 4a′ extending from a wire harness 4, a guide cover 6, a connecting case 7, a connecting case cover 8 and a mat seal 9 set in the connecting case 7 and the connecting case cover 8. If required, a case cover 3h is mounted on the auxiliary device module Z.

The camera case 3, as shown in FIG. 7, 8, 10, 11, 13 and 14, is formed with a bottom wall 3c and side walls 3d, 3d′ standing around the bottom wall to provide a receiving section 3e. The camera case 3 is provided on the inner four corners of the receiving section 3e with screw fixing bodies 3a , 3a′ to fix the base board 2, as shown in FIG. 7, 8.

A columnar projection 3g′ is formed on a top surface of the screw fixing body 3a′ to fit the base board 2 accurately into the receiving section 3e of the camera case 3, as shown in FIG. 7, 8, 10, 11, 13 and 14. A pair of the columnar projections 3g′ are formed on the screw fixing bodies 3a′ located mutually on diagonal position in the screw fixing bodies 3a , 3a′ provided on the inner four corners of the receiving section 3e of the camera case 3, as shown in FIG. 7, 8.

A pair of female tapped holes 3b are formed on the screw fixing bodies 3a located mutually on diagonal position in the screw fixing bodies 3a , 3a′ provided on the inner four corners of the receiving section 3e of the camera case 3.

A pair of the columnar projections 3g′ and a pair of female tapped holes 3b are provided respectively on the screw fixing bodies 3a, 3a′ provided on the inner four corners of the receiving section 3e of the camera case 3 to fit the base board 2 accurately and easily into the camera case 3, as shown in FIG. 7, 8.

Mounting holes 3b′ are provided on four corner of the camera case 3, as shown in FIG. 7, 8, to mount the camera module Z on a car body or any required positions or mount a case cover for protecting a camera on the camera module Z if required. Describing in detail, four mounting holes 3b′ are provided on four corners of each side walls 3d, 3d′ to form the camera case 3.

A connector housing 5j is formed integrally with the camera case 3 in the receiving section 3e of the camera case 3, as shown in FIG. 8, 11 and 14. The connector housing 5j may be formed separately from the camera case 3. Preferably, the connector housing 5j is formed integrally with the camera case 3 to reduce numbers of elements for miniaturization, weight saving and cost down.

The connector housing 5j is provided with a bottom wall 5k and side walls 5k′, 5k″ surrounding four side edges of the bottom wall 5k to form into a receiving section 5m. Six setting portions 5m′ as the same number of the cables 4a, 4a′ for supporting the cables 4a, 4a′ in a row are provided, projecting from the bottom wall 5k of the connector housing 5j, at even intervals and in a row.

Six through holes 5o for inserting the cables 4a, 4a′ are provided at even intervals and in a row and correspondingly to the setting portion 5m′ for supporting the cables 4a, 4a on the side wall 5k″ of the connector housing 5j. Since the side wall 5k″ of the connector housing 5j and the side wall 3d′ of the camera case 3 are formed integrally as shown in FIG. 8 and 11, each through hole 5o is formed into one continuous through hole from the side wall 5k″ of the connector housing 5j to the side wall 3d′ of the camera case 3.

A under portion of the bottom wall 5k of the connector housing 5j is formed into a lightening hole shape as shown in FIG. 11 and 14. Describing specifically, the connector housing 5j is formed integrally with a bottom wall 3c of the camera case 3 and the bottom wall 5k of the connector housing 5j is formed to serve as the bottom wall 3c of the camera case 3.

A area of the bottom wall 3c of the camera case 3 serving as the bottom wall 5k of the connector housing 5j is formed into a lightening hole shape to sink in toward the receiving section 3e of the camera case 3 from other area of the bottom wall 3c forming the camera case 3. Thereby, the camera case 3 can be miniaturized and material cost can be saved and then lightweight and low-cost camera module Z can be provided.

A guide cover 6, as shown in FIG. 7, is mounted to cover on an opening portion 5n as a top portion of the connector housing 5j shown in FIG. 8. Guide portions 6a i.e. openings 6a for guiding the pressure contact type terminals 5e accurately to the cables 4a, 4a′ are provided penetratingly in staggering row on required positions of the guide cover 6.

Thus, providing the openings 6a in staggering row on the guide cover 6, the connector housing 5j can be miniaturized and thereby the camera case 3 can be miniaturized and the camera module Z can be miniaturized finally.

The cables 4a and the drain wire 4a placed underneath each opening 6a are recognized by FIG. 7. Pressure contact connecting respective cable 4a, 4a′ at two position for secure connection, two openings 6a are provided for each cable 4a, 4a′ and then total twelve openings 6a are formed on the guide cover 6.

The guide cover 6 is fit into the opening portion 5n of the connector housing 5j as shown in FIG. 10, 11, 13 and 14. The guide cover 6 is formed with a projected portion corresponding to the opening portion 5n shape of the connector housing 5j. The projected portion of the guide cover 6 is fit into the opening portion 5n of the connector housing 5j and then the guide cover is mounted securely on the connector housing 5j.

The connecting case 7 is formed on the side wall 3d of the camera case 3 integrally with the camera case 3, as shown in FIG. 8, 10, 11 and 17. The connecting case cover 8, as shown in FIG. 7, is covered on a top portion of the connecting case 7 shown in FIG. 8.

Looking in vertical sectional views of FIG. 10 and 11, the connecting case cover 8, as shown in FIG. 10, is covered on the top of the connecting case 7 shown in FIG. 11. Looking in front views of FIG. 16 and 17, the connecting case cover 8, as shown in FIG. 16, is covered on the connecting case 7 shown in FIG. 17.

A facing potion i.e. a boundary portion of the connecting case 7 and connecting case cover 8 is designed to be located near side of the connecting case 7 from a center of the wire harness 4 but not to be located on the center of the wire harness 4, as shown in FIG. 16 and 17.

Engaging a pair of engaging portions 8g of the connecting case cover 8, shown in FIG. 7, 16, with a pair of locking portions 7g provided on the connecting case 7 as shown in FIG. 8 and 17, the connecting case 7 and the connecting case cover 8 are locked securely.

A guide plate 7d of the connecting case 7 is formed into a lightening hole shape to sink in toward the receiving section 7c of the connecting case 7, as shown in FIG. 11. Thereby, lightweight and low-cost camera module Z can be provided.

Description on other area of the connecting case 7 is almost same as mentioned above in FIG. 1, 2, 6, and omitted herein. Description on other area of the connecting case cover 8 is almost same as mentioned above in FIG. 1, 6, then omitted herein.

A mat seal 9 is provided in a receiving section 7c of the connecting case 7, as shown in FIG. 8, 11 and 17. The mat seal 9 is formed in advance with through holes 9a. The through hole 9a is provided at two inner positions with smaller diameter portions than the diameter of the cables 4a, 4a′ for enhancing sealing performance, as shown in FIG. 8 and 11.

The through hole 9a is formed to be narrowed from a open end of the through hole 9a of the mat seal 9 inwardly and to be enlarged to almost same size of the open end of the through hole 9a of the mat seal 9 in the central area. Inserting the cables 4a, 4a′ into such shaped through holes 9a, the cables 4a, 4a′ are sealed securely at the mat seal 9.

The mat seal 9 set into the connecting case 7, as shown in FIG. 10, is protected from outside and prevents water or dust infiltrating into the camera case 3 by mounting the connecting case cover 8 on the connecting case 7. Description on the other area of the mat seal 9 is almost same as the description mentioned above on FIG. 1, 2, 6, then omitted herein

The electric wires 4, 4a, 4a′ such as cables 4a, 4a′ extending from the wire harness 4, as shown in FIG. 7, 10, 13 and 16, are arranged in the camera case 3 provided with the connecting case 7, the connecting case cover 8, the mat seal 9 and the connector housing 5, mentioned above.

The camera module Y is built up by the auxiliary device 1 such as the camera 1 provided with CCD, the pressure contact type connector 5a provided with the terminals 5e such as the pressure contact type terminals 5e and the connector housing 5b and the base board 2, as shown in FIG. 9, 12 and 15. The camera 1 provided with CCD includes a lens 1c and a lens area portion 1d, as shown in FIG. 12 and 15.

Two positioning holes 2f to fix the base board 2 accurately on the camera case 3 are located mutually on diagonal position near the four corners of the base board 2, as shown in FIG. 9, correspondingly to the columnar projection 3g′ as mentioned above with reference to FIG. 7 and 8. Two screw through holes 2b to fix the base board 2 on the camera case 3 by fastenings such as screws are located mutually on diagonal position near the four corners of the base board 2, as shown in FIG. 9, correspondingly to the tapped holes 3b as mentioned above with reference to FIG. 7 and 8.

Thus, a pair of the positioning holes 2f and a pair of screw through holes 2b to fix the base board 2 on the camera case 3 are provided respectively near the four corners of the base board 2 to fit the base board 2 accurately and easily into the camera case 3, as shown in FIG. 9.

The base board body 2′, as shown in FIG. 9, is formed on the four corners with cutouts 2d correspondingly to the four corners of the receiving section 3e of the camera case 3 shown in FIG. 7 and 8. The base board body 2′ is provided with various electric circuits such as various bus bars for connecting respective electric wiring, terminals and electric wires. Description on the other area of the camera 1 with CCD and the base board 2 is almost same as mentioned above, then omitted herein.

The pressure contact type connector 5a, as shown in FIG. 9, 12 and 15, is provided with the pressure contact type terminals 5e and the connector housing 5b formed with a top wall 5c and a pair of guide portions 5d standing on both side edges of the top wall 5c. The guide portion 5d is formed into plate shape on the both side edges with ribs to reinforce the guide portion 5d forming the connector housing 5b provided in the pressure contact type connector 5a.

The pressure contact type connector 5a, as shown in FIG. 9 and 12, is mounted on the base board 2 to align one end surface of the connector housing 5b with one edge surface 2e′ of respective edge surface 2e, 2e′ of the baseboard 2. Description on the other area of the pressure contact type connector 5a and the connector housing 5b is almost same as description mentioned above in FIG. 1 and 3, then omitted herein.

Total twelve pressure contact type terminals 5e, as shown in FIG. 9 and 15, are provided in stagger and in a row on required positions of the top wall 5c forming the connector housing 5b, correspondingly to respective openings 6a of the guide cover 6 shown in FIG. 7. Providing the pressure contact type terminals 5e in stagger and in a row on the top wall 5c of the connector housing 5b, the connector housing 5b can be sized smaller. Therefore, camera case 3 can be miniaturized and finally the camera module Z can be miniaturized. Description on the other area of the pressure contact type terminal 5e is almost same as description mentioned above in FIG. 3 and 4.

When the pressure contact type terminals 5e shown in FIG. 13 and the cables 4a are pressure contact connected, through process from starting pressure contact connecting to end will be described in detail with reference to FIG. 18-20.

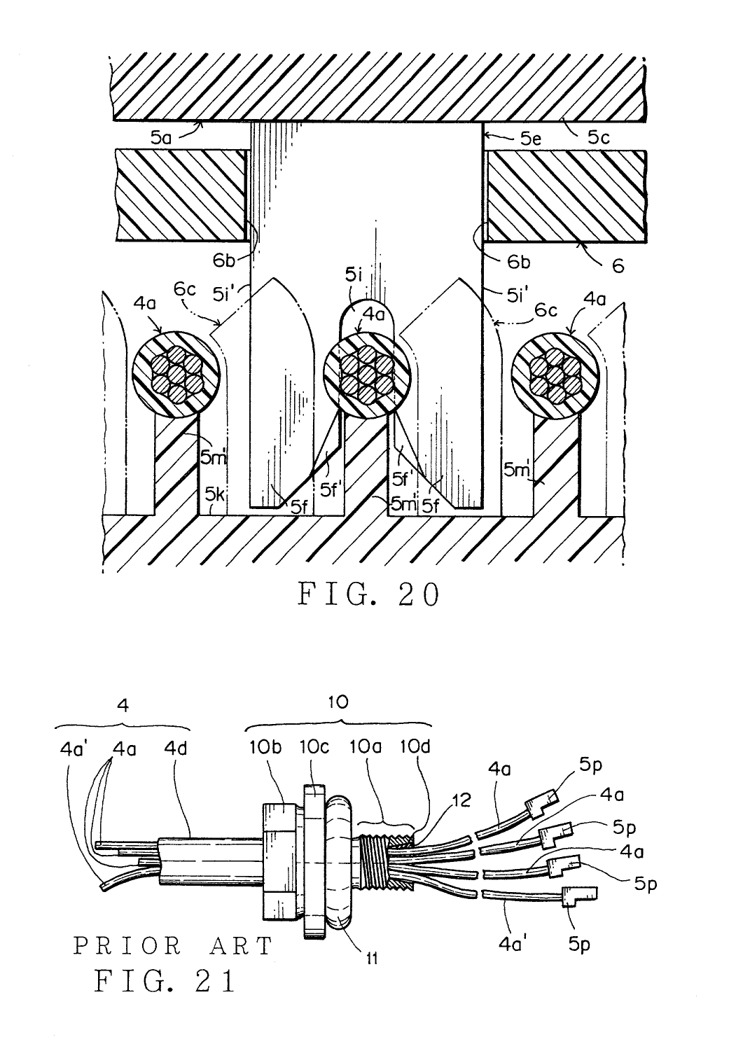

FIG. 18 is an expanded view, showing starting process for connecting the pressure contact type terminal 5e with the cable 4a, shown in FIG. 13, through the opening 6a as guide portion 6a. FIG. 19 is an expanded view, showing process after starting for connecting the pressure contact type terminal 5e with the cable 4a, shown in FIG. 18, through the opening 6a. FIG. 20 is an expanded view, showing finished condition for connecting the pressure contact type terminal 5e with the cable 4a, shown in FIG. 19.

The pressure contact type terminals 5e are mounted on the top wall 5c of the pressure contact type connector 5a, as shown in FIG. 18. Describing a shape of the pressure contact type terminal 5e, two slant portions 5g are formed to face each other and two pressure contact blades 5f are aligned in parallel to form the pressure contact type terminal 5e. A pressure contact slit 5i is provided in the pressure contact type terminal 5e. Thus, the pressure contact type terminal 5e is formed in an opening area for inserting the cables 4a with a couple of the slant portions 5g provided with blade portions 5f′ having oblique sharp-edged shape.

The pressure contact type terminal 5e is formed in the center area with the pressure contact slit 5i dimensioned narrower than diameters of the cables 4a to receive the conductive wires 4b of the cables 4a and wider not to dig into the bundled conductive wires 4b over requirement or cut a circuit.

The pressure contact slit 5i is formed into U-shape and dimensioned on the length to hold securely the conductive wire 4b of the cable 4a and not to reduce remarkably mechanical strength of the pressure contact type terminal 5e. The pressure contact type terminal 5e formed with a pair of the pressure contact blades 5f formed into such shape can serve good connecting by pressure contact. A side edge portion 5i′ is formed in parallel with the pressure contact slit 5i. Edge portions 5h are formed perpendicularly to the pressure contact slit 5i and the side edge portion 5i′ for safety.

The guide cover 6 is provided to cover the receiving section 5m of the connector housing. The guide cover 6 is provided with the openings 6a for performing as guides. The opening 6a is formed with a pair of side walls 6b and other pair of side walls perpendicular to the side walls 6b to form into rectangular shape correspondingly to the pressure contact type terminal 5e.

Distance from one side wall 6b to other side wall 6b of the opening 6a is dimensioned slightly longer than distance from one side edge portion 5i′ to other side edge portion 5i′ of the pressure contact type terminal 5e corresponding to the opening, i.e. the pressure contact type terminal 5e width, for guiding to insert easily and accurately the pressure contact type terminal 5e into the cable 4a set in the receiving section 5m of the connector housing. Surface shape of the setting portions 5m′ for supporting the cable 4a is formed into arc shape corresponding to circular section of the cable 4a to support the cable 4a satisfactorily.

Regarding the receiving section 5m of the connector housing 5j shown in FIG. 8, 11 and 14, if wire fixing portions 6c are provided on the bottom wall 5k of the connector housing as shown in FIG. 18-20, the cable 4a may not be shifted and not be moved from the setting portion 5m′ when starting pressure contact connection to push the pressure contact type terminal 5e onto the cable 4a. Therefore, pressure contact connection can be done stably.

The wire fixing portions 6c are provided at even intervals and in a row between adjacent setting portions 5m′ of the cable 4a and between a side wall of the connector housing and the setting portion 5m′. At least one of wire fixing portions 6c between the side wall of the connector housing and the setting portion 5m′ may be eliminated based on shape or specification of the connector housing. Two wire fixing portions 6c as a pair are provided for one cable 4a along a fitting direction of the cable 4a to be located in divided position for the center of mounting position of the pressure contact type terminal 5e and not to interfere with the pressure contact type terminals 5e when connecting.

Describing in detail, if terminal side of the wire harness 4 inserted into the camera case 3 is placed in a front side and the opposite side of the wire harness is placed in a rear side, a pair of the wire fixing portions 6c may be provided in front and behind for the position of connected pressure contact type terminal 5e as the center on the bottom wall 5k of the connector housing. Thus, providing a pair of the wire fixing potions 6c for one cable 4a on the bottom wall 5k of the connector housing, the pressure contact type terminals 5e and the cables 4a are connected securely.

The wire fixing portion 6c, shown in FIG. 18-20, is provided with a pillar portion 6e, a slant portion 6g formed into arcuately slant shape and an end edge portion 6i. The slant portion 6g may be formed into arcuately slant shape and also can be formed into almost straight shape. The wire fixing portions 6c, provided with the slant portion 6g formed into arcuately slant shape as shown in FIG. 18, are provided on the bottom wall 5k of the connector housing to align all end edge portions 6i facing the same direction.

Preferably, seven wire fixing portions 6c may be provided in front side and seven wire fixing portions 6c may be provided in behind side, then total fourteen wire fixing portions 6c may be provided in the receiving section 5m of the connector housing to hold securely total six cables 4a set in the receiving section 5m of the connector housing.

Not shown in a drawing, the seven wire fixing portions 6c which are provide in front of the position of the pressure contact type terminal 5e may be aligned to face the end edge portion 6i toward one direction and the other seven wire fixing portions 6c which are provided in behind of the position of the pressure contact type terminal 5e may be aligned to face the end edge portion 6i toward opposite direction on the bottom wall 5k of the connector housing.

Thereby, the cable 4a is held satisfactorily in up-and-down direction and right-and-left direction of the cable 4a by the setting portion 5m′ and the wire fixing portions 6c when connecting the pressure contact type terminal 5e with the cable 4a. Therefore, pressure contact connecting can be done more securely.

Gap distance 6j between adjacent wire fixing portions 6c of each other or minimum gap distance 6j between the wire fixing portion 6c and a side wall of the connector housing is dimensioned smaller than a diameter of the cable 4a. Specifically, the gap distance 6j between the end edge portion 6i of wire fixing portions 6c facing to one direction and adjacent wire fixing portions 6c to the above wire fixing portions 6c is smaller than a diameter of the cable 4a.

When setting the cable 4a on the setting portion 5m′, the wire fixing portion 6c made of a elastic material such as synthetic resin is deformed elastically and moderately to insert the cable 4a toward the setting portion 5m′. After that, the cable 4a is set onto the setting portion 5m′.

Holding the cable 4a temporarily on the setting portion 5m′ in the receiving section 5m of the connector housing may prevent an issue of unsatisfactory pressure contact connecting of the pressure contact type terminal 5e and the cable 4a by the cable 4a coming off from the setting portion 5m′. The cable 4a may be held to contact with the wire fixing portion 6c or may be kept to have a suitable gap for the wire fixing portion 6c without contacting to each other, as shown in FIG. 18-20.

FIG. 18 shows a starting condition of inserting the pressure contact type terminal 5e mounted on the top wall 5c of the pressure contact type connector 5a into the guide portion 6a i.e. opening 6a of the guide cover 6 mounted on the connector housing along a mount direction S3. The condition that the side edge portion 5i′ of the pressure contact type terminal 5e is inserted to be guided by the side walls 6b of the opening 6a is shown in FIG. 18.

Before pressure contact connecting, the pressure contact slit 5i of the pressure contact type terminal 5e can be placed accurately and easily right above the cable 4a, because the opening 6a formed in the guide cover 6 is placed right above the setting portion 5m′ for the cable 4a provided in the receiving section 5m of the connector housing.

Pressure contact connecting is started as shown in FIG. 19 by pushing down the pressure contact type terminal 5e shown in FIG. 18 along a mount direction S3. The pressure contact slit 5i of the pressure contact type terminal 5e is accurately biting the cable 4a to guide the side edge portion 5i′ of the pressure contact type terminal 5e by the side walls 6b of the opening 6a of the guide cover 6.

In this operation, a pair of the pressure contact blades 5f of the pressure contact type terminal 5e is deformed in a moment to extend toward outside. When a extending dimension of a pair of the pressure contact blades 5f, based on a dimension, shape and material of the pressure contact type terminal 5e, becomes unexpected large, a pair of the side walls of the opening 6a may hopefully control moderately the extending dimension of a pair of the pressure contact blades 5f formed in the pressure contact type terminal 5e for satisfactory pressure contact connecting.

Plastic deformation of the pressure contact type terminal 5e may be prevented by controlling a extending dimension of a pair of the pressure contact blades 5f formed in the pressure contact type terminal 5e. An issue that electrical contact failure between the conductive wire in the cable 4a and the pressure contact slit 5i is caused by plastic deformation to keep slight extending of the pressure contact slit 5i toward outside during connecting may be prevented.

It is a possible issue that pressure contact connecting may be done unsatisfactorily because the cable 4a slips from the setting portion 5m′ down to the bottom wall 5k of the connector housing to escape from contact pressure force loaded by the pressure contact type terminal 5e.

According to this invention, since moving of the cable 4a is limited by the setting portion 5m′ and the wire fixing portions 6c provided in right-and-left side of the cable 4a, the cable 4a may not be extremely shifted from the setting portion 5m′ and then unsatisfactory connection may be prevented.

Operation of pressure contact connecting, as shown in FIG. 20, is completed to push down more the pressure contact type terminal 5e along a mount direction S3. Pressure contact connection is completed to contact the conductive wire 4b of the cable 4a with the pressure contact slit 5i of the pressure contact type terminal 5e and thereby, the cable 4a and the pressure contact type terminal 5e are electrically continuous.

A wire fixing portion 6c having similar shape as the wire fixing portion 6c shown in FIG. 2 and 5 may be replaced for the wire fixing portion 6c shown in FIG. 18-20. Furthermore, cable area portions having similar shape of the wire fixing portion 6c and the setting portion 5m′ for the cable 4a shown in FIG. 18-20 may be provided in the receiving section 5m of the connector housing 5j shown in FIG. 2 and 5. Any means for fixing and supporting cables 4a, 4a′ may be applied in this invention.

Manufacturing method and assembling method for the camera module Z according to the other embodiment of this invention shown in FIG. 7-20 will be described simply. The mat seal 9 provided with the through holes 9a having required shape is mounted on the receiving section 7c formed in the connecting case 7 as shown in FIG. 8, 11 and 17. The wire harness 4 and the cable 4a and the drain wire 4a′ are placed in required positions.

Describing specifically, end portion of respective cables 4a and the drain wire 4a′ is inserted into the through hole 9a of the mat seal 9. Each cable 4a, 4a′ is led into the through hole 5o formed from the side wall 3d′ of the camera case 3 to one side wall 5k″ of the connector housing 5j and the cables 4a, 4a′ are placed to lead the end portion of each cable 4a, 4a′ through the through hole 5o of other side wall 5k″ of the connector housing 5j and make the end of each cable come out from the connector housing 5j. Thus, each cable 4a is placed as shown in FIG. 10.

As alternative process, firstly each cable 4a, 4a′ is inserted into respective through hole 9a of the mat seal 9 to make each cable 4a, 4a′ come out required length from the mat seal 9. Next, the mat seal 9 is mounted and the cable 4a, 4a′ coming out required length from the mat seal 9 is led through the through hole 5o formed in the side wall 5k″ of the connector housing 5j to place the cable 4a, 4a′ as shown in FIG. 10. Thus, placing the cable 4a in the connector housing 5j, assembling operation may be speeded up.

Respective cable is arranged in a row into each assigned guide groove 7e shown in FIG. 8. Thereafter, the connecting case cover 8 is mounted overlaying on the connecting case 7 as shown in FIG. 10 and 16. The connecting case 7 and the connecting case cover 8 are fixed securely by engaging a pair provided on the locking portions 7g with a pair of the engaging portions 8g provided on the connecting case cover 8 as shown in FIG. 7 and 16. Regarding assembling process of the connecting case cover 8, the connecting case cover 8 may be mounted after fitting the camera module Y including the base board 2 in the camera case 3, based on specification or application.

Respective cable 4a arranged in the receiving section 5m of the connector housing is set in a row on respective assigned wire setting portion 5m′ as shown in FIG. 18. In the process, the cables 4a may not move from the setting position during connecting operation by means of the wire fixing portions 6c provided on the both side of the cable 4a. Thereafter, the guide cover 6 is fit into the opening portion of the connector housing.

The camera module Y provided with the camera 1, the base board 2 and the pressure contact type connector 5a shown in FIG. 9, 12 and 15 is mounted on the camera case 3 as shown in FIG. 7, 10 and 13. In other words, the camera module Y is mounted on the camera case assembled with the wire harness 4, the cable 4a, 4a′ extending from the wire harness, the guide cover 6, the mat seal 9 and the connecting case cover 8. Pressure contact connection is completed to mount the camera module Y on the camera case 3 as shown in FIG. 18-20 and thereby, the camera 1 and the wire harness 4 are electrically continuous.

The case cover 3h may be provided in the auxiliary device module Z such as the camera module Z to protect the auxiliary device 1 such as the camera 1 as shown in FIG. 10, 13 and 16. The case cover 3h shown in FIG. 16 is provided on the four corners with counter boring portions 3a″ and screw through holes 3b″ corresponding to the counter boring portions. The counter boring portion 3a″ and the screw through holes 3b″ are provided correspondingly to the mounting holes 3b′, provided on the four corners of the camera case 3 shown in FIG. 7 and 8, in the case cover 3h shown in FIG. 16.

Fasteners such as bolts or screws are set into the counter boring portion 3a″ and the screw through holes 3b″ shown in FIG. 16. Thereafter, The case cover 3h is mounted on a required position of the camera case 3 to screw the fasteners such as bolts or screws into the mounting holes 3b′ provided on the four corners of the camera case 3 shown in FIG. 7.

Thus, any kind of additional elements may be mounted on the auxiliary device module according to this invention, based on requirements. Some additional elements such as the case cover 3h may be eliminated based on a used position of the auxiliary device or a mounting position of the auxiliary device. Thereby, number of elements can be reduced and then the auxiliary device module can be miniaturized and the weight and the cost also can be reduced.

The auxiliary device module according to this invention can be applied not only for the camera module Z mentioned above but also auxiliary device modules Z used for an instrument panel of a car or other related area and can be applied for any other area for modularization.

The camera module Z provided with the camera 1 including CCD, as auxiliary device 1, for a car is preferable in any auxiliary device modules. Applying the auxiliary device module Z according the invention for camera module Z mounted in a car, number of elements related with the camera module Z can be reduced and then, the camera module Z mounted in a car can be miniaturized and the weight and the cost also can be reduced.

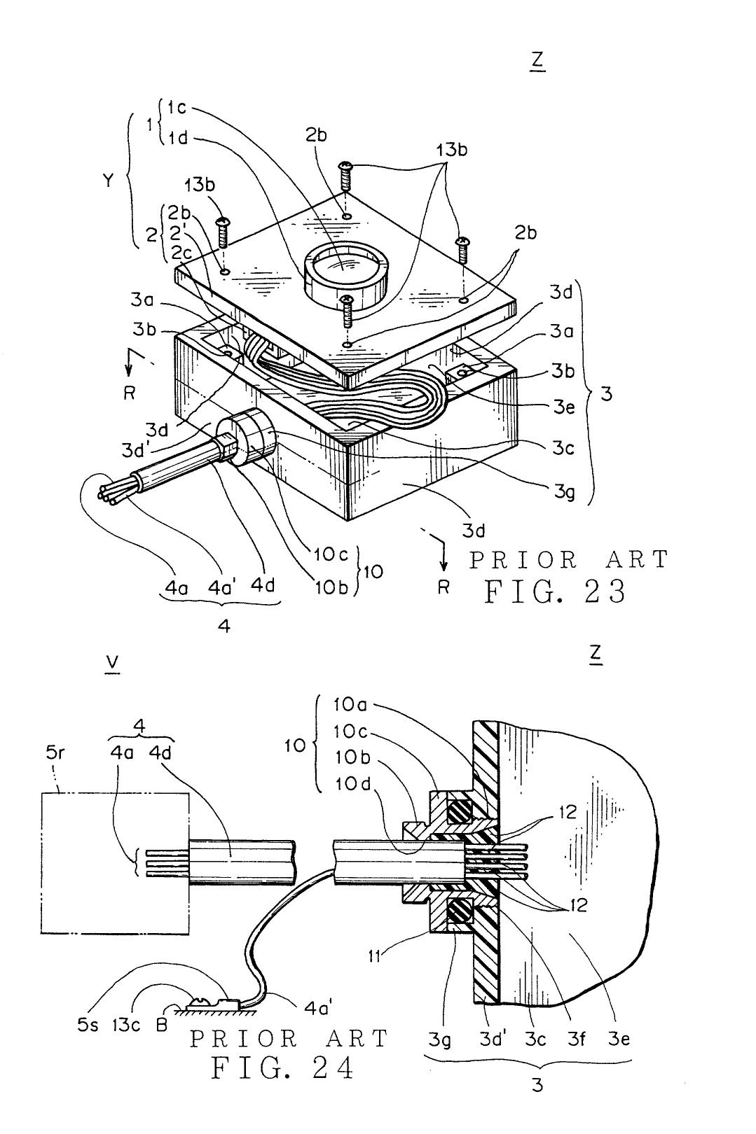

Assembling structure of the camera 1, the base board 2 and the camera case 3 for a car is simplified. Describing specifically, using pressure contact type terminals 5e show in FIG. 1, 10 and 13, the structure differs from a current camera module Z, shown in FIG. 21 and 24, in which crimp contact type terminals 5p are joined with the cables 4a, 4a′ and the assembly is set into the connector housing 5q and the connector housing 5q is connected with the connector housing 2c for the base board 2 as shown in FIG. 22, 23 and then electrical connection is done.

According to this invention, using pressure contact type terminals provided in the pressure contact type connector 5a, shown in FIG. 1, 10 and 13, for electrical connection, inspection, disassemble and repair can be done easily and also the camera module having good recyclability can be provided.

The camera module Z according to this invention is preferably used as an auxiliary member to ascertain safety of a dead angle to be installed in positions to look from a inside of a vehicle such as a dead angle area in front of a vehicle or rear area of a vehicle such as a normal size car or a large size car like a bus.

When a CCD camera installed on a outside of a car rear area strikes against others during moving back and checking or repairing of the CCD camera is required, a CCD camera according to this invention is easily disassembled and then the damaged CCD camera can be disassembled easily and repaired and reinstalled on the car. Therefore, a module according to this invention is used preferably as a CCD camera for ascertaining visually installed on a outside of a car rear area.

When a CCD camera or related elements installed on a car has a trouble such as a fault, removing , checking and repairing of them are required. A camera module Z according to this invention, installed and removed easily, has good maintainability. Since the camera module Z is disassembled easily, the camera module Z is easily recycled in case of scrapping and then conform to a environmental issue by industrial waste.

What is claimed is:

1. An auxiliary device module comprising:
an auxiliary device;
a base board provided with said auxiliary device and terminals; and
a case in which said base board is mounted, wherein said terminals of the base board and a connecting portion in said case are electrically connected as a connector by mounting said base board on the case, wherein a guide portion for guiding the terminals to the connecting portion is provided in said connector.

2. The auxiliary device module according to claim 1, wherein said terminals are pressure contact type terminals, wherein said connecting portion has electric wires, wherein a pressure contact type connector provided with said pressure contact type terminals is mounted on said base board, wherein said case is provided with a connector housing having said electric wires therein, wherein said connector is formed by press-fitting said base board into said case to connect said pressure contact type terminals with said electric wires by pressure, wherein said guide portion is formed with a plurality of openings, wherein at least one of said pressure contact type terminals, guided through She openings, is connected by pressure with a plurality of the electric wires corresponding to the terminals.

3. The auxiliary device module according to claim 1, wherein a camera module is built with a car-mount type camera as said auxiliary device.
